(19) United States
(12) Patent Application Publication
(10) Pub. No.: US 2015/0081790 A1
(43) Pub. Date: Mar. 19, 2015

(54) System and Method for Analyzing and Transmitting Social Communication Data

(71) Applicant: Marketwire L.P., Toronto (CA)

(72) Inventor: Stuart OGAWA, Los Gatos, CA (US)

(21) Appl. No.: 14/487,863

(22) Filed: Sep. 16, 2014

Related U.S. Application Data
(60) Provisional application No. 61/880,027, filed on Sep. 19, 2013.

(51) Int. Cl. H04L 12/18; G06F 17/30; H04L 29/08

(52) U.S. Cl. CPC H04L 12/1813; H04L 67/22; G06F 17/30876
USPC 709/204

(57) ABSTRACT

There is provided a system and method for transmitting social communication data across at least one social communication channel. The method is performed by a computing device for communicating social data, comprising: receiving a composed social data object; integrating at least one tracker object within the social data object; transmitting the social data object comprising said tracker object to at least one destination target; obtaining a response from said tracker object indicating target feedback, wherein the target feedback indicates at least one of: subsequent transmission of the social data object to additional destination targets and feedback parameters from at least one of: said at least one destination target and said additional destination targets.

### CROSS-REFERENCE TO RELATED APPLICATIONS

This application claims priority to U.S. Provisional Patent Application No. 61/880,027 filed on Sep. 19, 2013, and titled “System and Method for Continuous Social Communication”, the entire contents of which is incorporated herein by reference.

### TECHNICAL FIELD

The following generally relates to communication of social data and particularly, transmitting social communication data based upon feedback of earlier communications.

### BACKGROUND

In recent years social media has become a popular way for individuals and consumers to interact online (e.g. on the Internet). Social media also affects the way businesses aim to interact with their customers, fans, and potential customers online.

Typically a person or persons create social media by writing messages (e.g. articles, online posts, blogs, comments, etc.), creating a video, or creating an audio track. This process can be difficult and time consuming.

### BRIEF DESCRIPTION OF THE DRAWINGS

Embodiments will now be described by way of example only with reference to the appended drawings wherein:

FIG. 1 is a block diagram of a social communication system interacting with the Internet or a cloud computing environment, or both.

FIG. 2 is a block diagram of an example embodiment of a computing system for social communication, including example components of the computing system.

FIG. 3 is a block diagram of an example embodiment of multiple computing devices interacting with each other over a network to form the social communication system.

FIG. 4 is a schematic diagram showing the interaction and flow of data between an active receiver module, an active composer module, an active transmitter module and a social analytic synthesizer module.

FIG. 5 is a flow diagram of an example embodiment of computer executable or processor implemented instructions for composing new social data and transmitting the same.

FIG. 6 is a block diagram of an active receiver module showing example components thereof.

FIG. 7 is a flow diagram of an example embodiment of computer executable or processor implemented instructions for receiving social data.

FIG. 8 is a block diagram of an active composer module showing example components thereof.

FIG. 9A is a flow diagram of an example embodiment of computer executable or processor implemented instructions for composing new social data.

FIG. 9B is a flow diagram of an example embodiment of computer executable or processor implemented instructions for combining social data according to an operation described in FIG. 9A.

FIG. 9C is a flow diagram of an example embodiment of computer executable or processor implemented instructions for extracting social data according to an operation described in FIG. 9A.

FIG. 9D is a flow diagram of an example embodiment of computer executable or processor implemented instructions for creating social data according to an operation described in FIG. 9A.

FIG. 10 is a block diagram of an active transmitter module showing example components thereof.

FIG. 10A is a block diagram of an active transmitter module showing example components thereof in accordance with yet another embodiment.

FIG. 10B is a block diagram of example communication of a composed social media data with embedded trackers

FIG. 100 is a block diagram of exemplary components of a tracker for use in embedding in social media data messages.

FIG. 11 is a flow diagram of an example embodiment of computer executable or processor implemented instructions for transmitting the new social data.

FIG. 12 is a block diagram of a social analytic synthesizer module showing example components thereof.

FIG. 13 is a flow diagram of an example embodiment of computer executable or processor implemented instructions for determining adjustments to be made for any of the processes implemented by the active receiver module, the active composer module, and the active transmitter module.

FIG. 14 is a flow diagram showing an example for determining an inflection point.

### DETAILED DESCRIPTION OF THE DRAWINGS

It will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures and components have not been described in detail so as not to obscure the example embodiments described herein. Also, the description is not to be considered as limiting the scope of the example embodiments described herein.

Social data herein refers to content able to be viewed or heard, or both, by people over a data communication network, such as the Internet. Social data includes, for example, text, video, picture, photographs, graphics, and audio data, or combinations thereof. Examples of text include blogs, emails, messages, posts, articles, comments, etc. For example, text can appear on websites such as Facebook, Twitter, LinkedIn, Pinterest, other social networking websites, magazine websites, newspaper websites, company websites, blogs, etc. Text may also be in the form of comments on websites, text provided in an RSS feed, etc. Examples of video can appear on Facebook, YouTube, news websites, personal websites, blogs (also called vlogs), company websites, etc. Graphical data, such as pictures, can also be provided through the above mentioned outlets. Audio data can be provided through various websites, such as those mentioned above, audio-casts, “Pod casts”, online radio stations, etc. It is appreciated that social data can vary in form.

A social data object herein refers to a unit of social data, such as a text article, a video, a comment, a message, an audio track, a graphic, or a mixed-media social piece that includes different types of data. A stream of social data includes multiple social data objects. For example, in a string of comments from people, each comment is a social data object. In another example, in a group of text articles, each article is a social data object. In another example, in a group of videos, each video file is a social data object. Social data includes at least one social data object.

It is recognized that effective social communication, from a business perspective, is a significant challenge. The expansive reach of digital social sites, such as Twitter, Facebook, YouTube, etc., the real time nature of communication, the different languages used, and the different communication modes (e.g. text, audio, video, etc.) make it challenging for businesses to effectively listen to and communicate with their customers. The increasing number of websites, channels, and communication modes can overwhelm businesses with too much real time data and little appropriate and relevant information. It is also recognized that people in decision making roles in business are often left wondering who is saying what, what communication channels are being used, and which people are important to listen to.

It is recognized that typically a person or persons generate social data. For example, a person generates social data by writing a message, an article, a comment, etc., or by generating other social data (e.g. pictures, video, and audio data). This generation process, although sometimes partially aided by a computer, is time consuming and uses effort by the person or persons. For example, a person typically types in a text message, and inputs a number of computing commands to attach a graphic or a video, or both. After a person creates the social data, the person will need to distribute the social data to a website, a social network, or another communication channel. This is also a time consuming process that requires input from a person.

It is also recognized that when a person generates social data, before the social data is distributed, the person does not have a way to estimate how well the social data will be received by other people. After the social data has been distributed, a person may also not have a way to evaluate how well the content has been received by other people. Furthermore, many software and computing technologies require a person to view a website or view a report to interpret feedback from other people.

It is also recognized that generating social data that is interesting to people, and identifying which people would find the social data interesting is a difficult process for a person, and much more so for a computing device. Computing technologies typically require input from a person to identify topics of interest, as well as identify people who may be interested in a topic. It also recognized that generating large amounts of social data covering many different topics is a difficult and time-consuming process. Furthermore, it is difficult achieve such a task on a large data scale within a short time frame.

The proposed systems and methods described herein address one or more of these above issues. The proposed systems and methods use one or more computing devices to receive social data, identify relationships between the social data, compose new social data based on the identified relationships and the received social data, and transmit the new social data. In a preferred example embodiment, these systems and methods are automated and require no input from a person for continuous operation. In another example embodiment, some input from a person is used to customize operation of these systems and methods.

The proposed systems and methods are able to obtain feedback during this process to improve computations related to any of the operations described above. For example, feedback is obtained about the newly composed social data, and this feedback can be used to adjust parameters related to where and when the newly composed social data is transmitted. This feedback is also used to adjust parameters used in composing new social data and to adjust parameters used in identifying relationships. Further details and example embodiments regarding the proposed systems and methods are described below.

The proposed systems and methods may be used for real time listening, analysis, content composition, and targeted broadcasting. The systems, for example, capture global data streams of data in real time. The stream data is analyzed and used to intelligently determine content composition and intelligently determine who, what, when, and how the composed messages are to be sent.

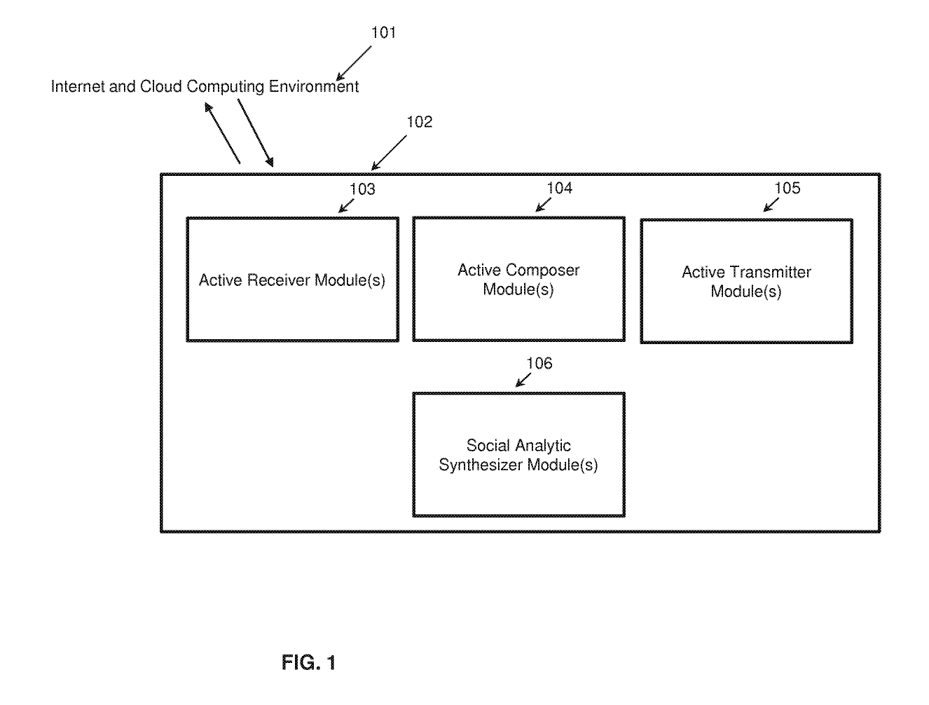

Turning to FIG. 1, the proposed system 102 includes an active receiver module 103, an active composer module 104, an active transmitter module 105, and a social analytic synthesizer module 106. The system 102 is in communication with the Internet or a cloud computing environment, or both 101. The cloud computing environment may be public or may be private. In an example embodiment, these modules function together to receive social data, identify relationships between the social data, compose new social data based on the identified relationships and the received social data, and transmit the new social data.

The active receiver module 103 receives social data from the Internet or the cloud computing environment, or both. The receiver module 103 is able to simultaneously receive social data from many data streams. The receiver module 103 also analyses the received social data to identify relationships amongst the social data. Units of ideas, people, location, groups, companies, words, number, or values are herein referred to as concepts. The active receiver module 103 identifies at least two concepts and identifies a relationship between the at least two concepts. For example, the active receiver module identifies relationships amongst originators of the social data, the consumers of the social data, and the content of the social data. The receiver module 103 outputs the identified relationships.

The active composer module 104 uses the relationships and social data to compose new social data. For example, the composer module 104 modifies, extracts, combines, or synthesizes social data, or combinations of these techniques, to compose new social data. The active composer module 104 outputs the newly composed social data. Composed social data refers to social data composed by the system 102.

The active transmitter module 105 determines appropriate communication channels and social networks over which to send the newly composed social data. The active transmitter module 105 is also configured receive feedback about the newly composed social data using trackers associated with the newly composed social data.

The social analytic synthesizer module 106 obtains data, including but not limited to social data, from each of the other modules 103, 104, 105 and analyses the data. The social analytic synthesizer module 106 uses the analytic results to generate adjustments for one or more various operations related to any of the modules 103, 104, 105 and 106.

In an example embodiment, there are multiple instances of each module. For example, multiple active receiver modules 103 are located in different geographic locations. One active receiver module is located in North America, another active receiver module is located in South America, another active receiver module is located in Europe, and another active receiver module is located in Asia. Similarly, there may be multiple active composer modules, multiple active transmitter modules and multiple social analytic synthesizer modules. These modules will be able to communicate with each other and send information between each other. The multiple modules allows for distributed and parallel processing of data. Furthermore, the multiple modules positioned in each geographic region may be able to obtain social data that is specific to the geographic region and transmit social data to computing devices (e.g. computers, laptops, mobile devices, tablets, smart phones, wearable computers, etc.) belonging to users in the specific geographic region. In an example embodiment, social data in South America is obtained within that region and is used to compose social data that is transmitted to computing devices within South America. In another example embodiment, social data is obtained in Europe and is obtained in South America, and the social data from the two regions are combined and used to compose social data that is transmitted to computing devices in North America.

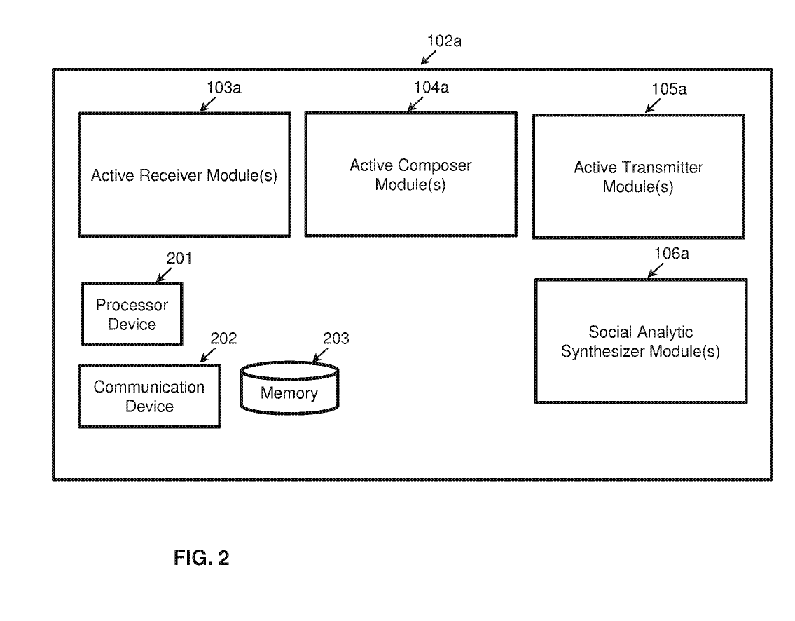

Turning to FIG. 2, an example embodiment of a system 102a is shown. For ease of understanding, the suffix “a” or “b”, etc. is used to denote a different embodiment of a previously described element. The system 102a is a computing device or a server system and it includes a processor device 201, a communication device 202 and memory 203. The communication device is configured to communicate over wired or wireless networks, or both. The active receiver module 103a, the active composer module 104a, the active transmitter module 105a, and the social analytic synthesizer module 106a are implemented by software and reside within the same computing device or server system 102a. In other words, the modules may share computing resources, such as for processing, communication and memory.

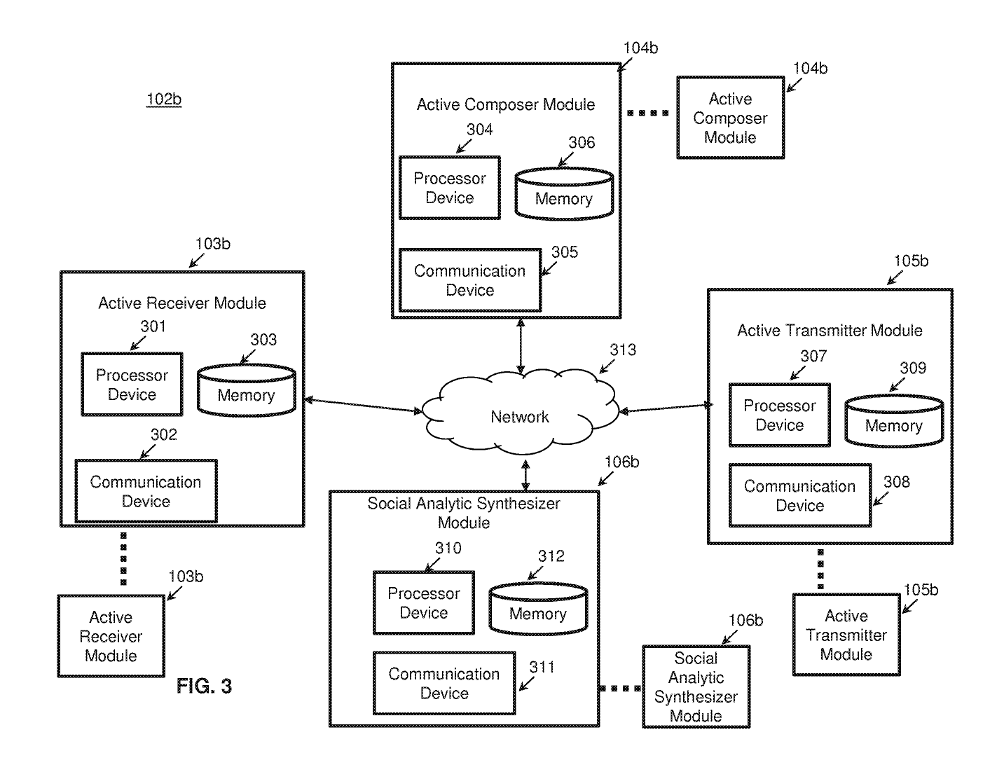

Turning to FIG. 3, another example embodiment of a system 102b is shown. The system 102b includes different modules 103b, 104b, 105b, 106b that are separate computing devices or server systems configured to communicate with each other over a network 313. In particular, the active receiver module 103b includes a processor device 301, a communication device 302, and memory 303. The active composer module 104b includes a processor device 304, a communication device 305, and memory 306. The active transmitter module 105b includes a processor device 307, a communication device 308, and memory 309. The social analytic synthesizer module 106b comprises a processor device 310, a communication device 311, and memory 312.

Although only a single active receiver module 103b, a single active composer module 104b, a single active transmitter module 105b and a single social analytic synthesizer module 106b are shown in FIG. 3, it can be appreciated that there may be multiple instances of each module 103b, 104b, 105b and/or 106b that are able to communicate with each other using the network 313. As described above with respect to FIG. 1, there may be multiple instances of each module and these modules may be located in different geographic locations.

It can be appreciated that there may be other example embodiments for implementing the computing structure of the system 102.

It is appreciated that currently known and future known technologies for the processor device, the communication device and the memory can be used with the principles described herein. Currently known technologies for processors include multi-core processors. Currently known technologies for communication devices include both wired and wireless communication devices. Currently known technologies for memory include disk drives and solid state drives. Examples of the computing device or server systems include dedicated rack mounted servers, desktop computers, laptop computers, set top boxes, and integrated devices combining various features. A computing device or a server uses, for example, an operating system such as Windows Server, Mac OS, Unix, Linux, FreeBSD, Ubuntu, etc.

It will be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the system 102, or any or each of the modules 103, 104, 105, 106, or accessible or connectable thereto. Any application or module herein described may be implemented using computer readable/executable instructions that may be stored or otherwise held by such computer readable media.

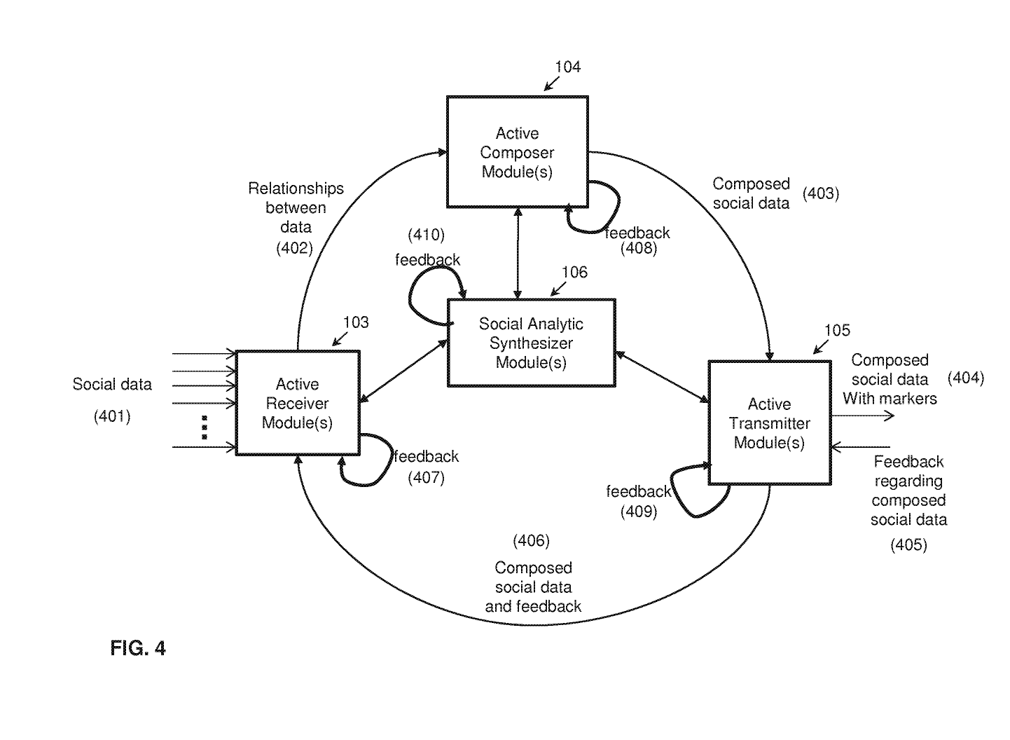

Turning to FIG. 4, the interactions between the modules are shown. The system 102 is configured to listen to data streams, compose automated and intelligent messages, launch automated content, and listen to what people are saying about the launched content.

In particular, the active receiver module 103 receives social data 401 from one or more data streams. The data streams can be received simultaneously and in real-time. The data streams may originate from various sources, such as Twitter, Facebook, YouTube, LinkedIn, Pintrest, blog websites, news websites, company websites, forums, RSS feeds, emails, social networking sites, etc. The active receiver module 103 analyzes the social data, determines or identifies relationships between the social data, and outputs these relationships 402.

In a particular example, the active receiver module 103 obtains social data about a particular car brand and social data about a particular sports team from different social media sources. The active receiver 103 uses analytics to determine there is a relationship between the car brand and the sports team. For example, the relationship may be that buyers or owners of the car brand are fans of the sports team. In another example, the relationship may be that there is a high correlation between people who view advertisements of the car brand and people who attend events of the sports team. The one or more relationships are outputted.

The active composer module 104 obtains these relationships 402 and obtains social data corresponding to these relationships. The active composer module 104 uses these relationships and corresponding data to compose new social data 403. The active composer module 104 is also configured to automatically create entire messages or derivative messages, or both. The active composer module 104 can subsequently apply analytics to recommend an appropriate, or optimal, message that is machine-created using various social data geared towards a given target audience.

Continuing with the particular example, the active composer module 104 composes a new text article by combining an existing text article about the car brand and an existing text article about the sports team. In another example, the active composer module composes a new article about the car brand by summarizing different existing articles of the car brand, and includes advertisement about the sports team in the new article. In another example, the active composer module identifies people who have generated social data content about both the sports team and the car brand, although the social data for each topic may be published at different times and from different sources, and combines this social content together into a new social data message. In another example embodiment, the active composer module may combine video data and/or audio data related to the car brand with video data and/or audio data related to the sports team to compose new video data and/or audio data. Other combinations of data types can be used.

The active transmitter module 105 obtains the newly composed social data 403 and determines a number of factors or parameters related to the transmission of the newly composed social data. The active transmitter module 105 also inserts or adds markers to track people's responses to the newly composed social data. Based on the transmission factors, the active transmitter module transmits the composed social data with the markers 404. The active transmitter module is also configured to receive feedback regarding the composed social data 405, in which collection of the feedback includes use of the markers. The newly composed social data and any associated feedback 406 are sent to the active receiver module 103.

Continuing with the particular example regarding the car brand and the sports team, the active transmitter module 105 determines trajectory or transmission parameters. For example, social networks, forums, mailing lists, websites, etc. that are known to be read by people who are interested in the car brand and the sports team are identified as transmission targets. Also, special events, such as a competition event, like a game or a match, for the sports team are identified to determine the scheduling or timing for when the composed data should be transmitted. Location of targeted readers will also be used to determine the language of the composed social data and the local time at which the composed social data should be transmitted. Markers, such as number of clicks (e.g. click through rate), number of forwards, time trackers to determine length of time the composed social data is viewed, etc., are used to gather information about people's reaction to the composed social data. The composed social data related to the car brand and the sports team and associated feedback are sent to the active receiver module 103.

Continuing with FIG. 4, the active receiver module 103 receives the composed social data and associated feedback 406. The active receiver module 103 analyses this data to determine if there are any relationships or correlations. For example, the feedback can be used to determine or affirm that the relationship used to generate the newly composed social data is correct, or is incorrect.

Continuing with the particular example regarding the car brand and the sports team, the active receiver module 103 receives the composed social data and the associated feedback. If the feedback shows that people are providing positive comments and positive feedback about the composed social data, then the active receiver module determines that the relationship between the car brand and the sports team is correct. The active receiver module may increase a rating value associated with that particular relationship between the car brand and the sports team. The active receiver module may mine or extract even more social data related to the car brand and the sports team because of the positive feedback. If the feedback is negative, the active receiver module corrects or discards the relationship between the car brand and the sports team. A rating regarding the relationship may decrease. In an example embodiment, the active receiver may reduce or limit searching for social data particular to the car brand and the sports team.

Periodically, or continuously, the social analytic synthesizer module 106 obtains data from the other modules 103, 104, 105. The social analytic synthesizer module 106 analyses the data to determine what adjustments can be made to the operations performed by each module, including module 106. It can be appreciated that by obtaining data from each of modules 103, 104 and 105, the social analytic synthesizer has greater contextual information compared to each of the modules 103, 104, 105 individually.

The proposed systems and methods described herein relate to receiving and analyzing social data from one or more associated modules (e.g. 103, 104, 105), the modules for receiving, composing and/or transmitting social data and communicating with external targets of the social data regarding same. The social data can be used in, for example, but is not limited to, the context of continuous social communication. In other words, the system architecture and operations related to the social analytic synthesizer module, described below, may be used with the continuous social communication system described herein, may be used in isolation, or may be used with other systems not described here.

### Active Transmitter Module 105

One measure of positive feedback is for example: the number of times that a particular social media data was re-transmitted or forwarded (e.g. re-tweeted or shared on social media sites). Another measure of positive feedback is the new destination of the messages being forwarded. For example, a social media data message intentioned for one geographical country (e.g. Brazil) may be forwarded by users to other geographical South American countries. Thus, the social analytic synthesizer modules 106 is configured for receiving feedback regarding the final destination or final destinations of messages generated by the system 102 and detecting the rerouting of the messages. In response, the synthesizer module 106 is configured for altering one or more subsequent social media data to the detected final destination of prior similar messages.

In yet another aspect, the one or more modules 103, 104 and 105 are configured to provide their respective social media data and/or feedback received relating to the data based on defined timing.

As discussed earlier, the social data object herein refers to a unit of social data, such as a text article, a video, an image, a picture, a photo, a comment, a message, an audio track, a graphic, or a mixed-media social piece that includes different types of data. As can be envisaged, the social data object can include any combination of the above or a plurality of each category, such as video(s), image(s), comment(s) . . . .

One of the aforementioned social data object content (e.g. representing an advertisement or campaign content) could comprise two different versions of the content (e.g. a first content that is initially longer in duration and transmitted/displayed for a duration of n days and another abbreviated version that is subsequently transmitted or displayed). As an example, this is common for tv advertisers when first introducing a new campaign that lasts 30 seconds and then is subsequently shortened to 15 seconds as a follow up to provide reminders about the company and product.

### Social Analytic Synthesizer Module 106—Adjusting Operations of System 102

In response, the social media data and/or feedback is forwarded to the social analytic synthesizer module 106 for further altering the operation of the modules 103, 104, and/or 105. For example, subsequent social media data may be tailored to include one or more of: format, content, geographical destination, language, particular target destinations, provided as exemplary adjustments. In one example, the synthesizer module 106 may receive positive feedback regarding social media data transmitted during certain times or dates. Accordingly, the synthesizer module 106 is configured to alter subsequent similar messages to be scheduled according to this knowledge.

In one embodiment, the social analytic synthesizer module 106 is configured for providing the suggested adjustments to the respective module 103, 104, and/or 105. In another embodiment, the social analytic synthesizer module 106 is configured to define the adjusted social media data (e.g. new content, new language, new format, and new target destination) and to forward the new social data to the respective module for transmission to one or more targets.

Continuing with the particular example regarding the car brand and the sports team, the social analytic synthesizer module 106 obtains data that people are responding positively to the newly composed social data object in a second language different than a first language used in the newly composed social data object. Such information can be obtained from the active transmitter module 105 or from the active receiver module 103, or both. Therefore, the social analytic synthesizer module sends an adjustment command to the active composer module 104 to compose new social data about the car brand and the sports team using the second language.

In another example, the social analytic synthesizer module 106 obtains data that positive feedback, about the newly composed social data object regarding the car brand and the sports team, is from particular geographical vicinity (e.g. a zip code, an area code, a city, a municipality, a state, a province, etc.). This data can be obtained by analyzing data from the active receiver module 103 or from the active transmitter module 105, or both. The social analytic synthesizer then generates and sends an adjustment command to the active receiver module 103 to obtain social data about that particular geographical vicinity. Social data about the particular geographical vicinity includes, for example, recent local events, local jargon and slang, local sayings, local prominent people, and local gathering spots. The social analytic synthesizer generates and sends an adjustment command to the active composer module 104 to compose new social data that combines social data about the car brand, the sports team and the geographical vicinity. The social analytic synthesizer generates and sends an adjustment command to the active transmitter module 105 to send the newly composed social data to people located in the geographical vicinity, and to send the newly composed social data during time periods when people are likely to read or consume such social data (e.g. evenings, weekends, etc.).

Continuing with FIG. 4, each module is also configured to learn from its own gathered data and to improve its own processes and decision making algorithms. Currently known and future known machine learning and machine intelligence computations can be used. For example, the active receiver module 103 has a feedback loop 407; the active composer module 104 has a feedback loop 408; the active transmitter module 105 has a feedback loop 409; and the social analytic synthesizer module has a feedback loop 410. In this way, the process in each module can continuously improve individually, and also improve using the adjustments sent by the social analytic synthesizer module 106. This self-learning on a module-basis and system-wide basis allows the system 102 to be completely automated without human intervention.

It can be appreciated that as more data is provided and as more iterations are performed by the system 102 for sending composed social data, then the system 102 becomes more effective and efficient.

Other example aspects of the system 102 are described below.

The system 102 is configured to capture social data in real time.

The system 102 is configured to analyze social data relevant to a business or, a particular person or party, in real time.

The system 102 is configured to create and compose social data that is targeted to certain people or a certain group, in real time.

The system 102 is configured to determine the best or appropriate times to transmit the newly composed social data.

The system 102 is configured to determine the best or appropriate social channels to reach the selected or targeted people or groups.

The system 102 is configured to determine what people are saying about the new social data sent by the system 102.

The system 102 is configured to apply metric analytics to determine the effectiveness of the social communication process.

The system 102 is configured to determine and recommend analysis techniques and parameters, social data content, transmission channels, target people, and data scraping and mining processes to facilitate continuous loop, end-to-end communication.

The system 102 is configured to add N number of systems or modules, for example, using a master-slave arrangement.

It will be appreciated that the system 102 may perform other operations.

In an example embodiment, computer or processor implemented instructions, which are implemented by the system 102, for providing social communication includes obtaining social data. The system then composes a new social data object derived from the social data. It can be appreciated that the new social data object may have exactly the same content of the obtained social data, or a portion of the content of the obtained social data, or none of the content of the obtained social data. The system transmits the new social data object and obtains feedback associated with the new social data object. The system computes an adjustment command using the feedback, wherein executing the adjustment command adjusts a parameter used in the operations performed by the system.

In an example embodiment, the system obtains a social data object using the active receiver module, and the active composer module passes the social data object to the active transmitter module for transmission. Computation and analysis is performed to determine if the social data object is suitable for transmission, and if so, to which party and at which time should the social data object be transmitted.

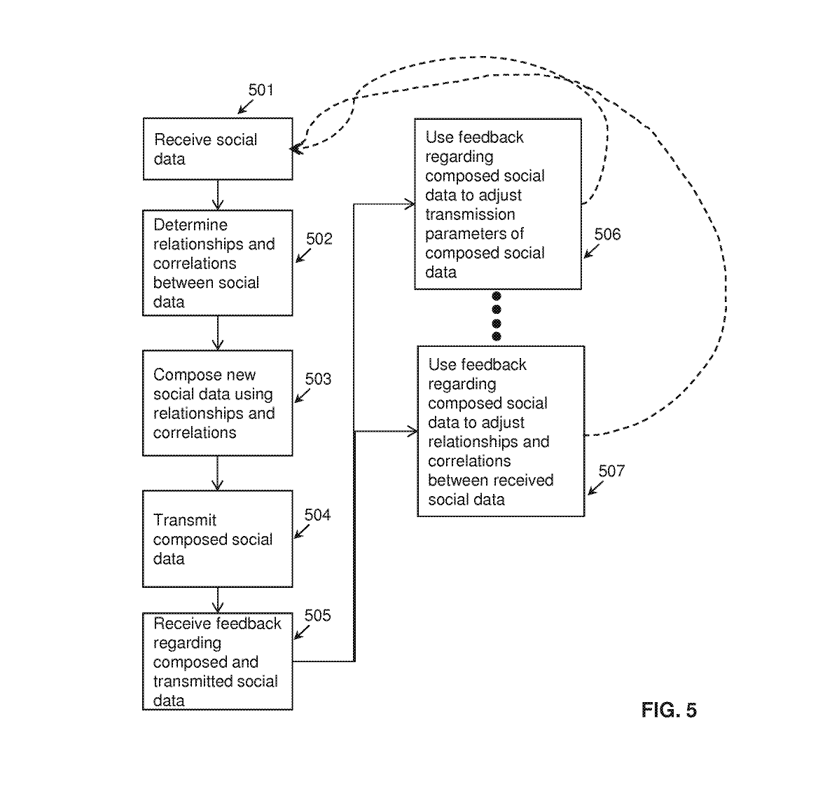

Another example embodiment of computer or processor implemented instructions is shown in FIG. 5 for providing social communication. The instructions are implemented by the system 102. At block 501, the system 102 receives social data. At block 502, the system determines relationships and correlations between social data. At block 503, the system composes new social data using the relationships and the correlations. At block 504, the system transmits the composed social data. At block 505, the system receives feedback regarding the composed social data. At block 506, following block 505, the system uses the feedback regarding the composed social data to adjust transmission parameters of the composed social data. In addition, or in the alternative, at block 507, following block 505, the system uses the feedback regarding the composed social data to adjust relationships and correlations between the received social data. It can be appreciated that other adjustments can be made based on the feedback. As indicated by the dotted lines, the process loops back to block 501 and repeats.

### Active Receiver Module

The active receiver module 103 automatically and dynamically listens to N number of global data streams and is connected to Internet sites or private networks, or both. The active receiver module may include analytic filters to eliminate unwanted information, machine learning to detect valuable information, and recommendation engines to quickly expose important conversations and social trends. Further, the active receiver module is able to integrate with other modules, such as the active composer module 104, the active transmitter module 105, and the social analytic synthesizer module 106.

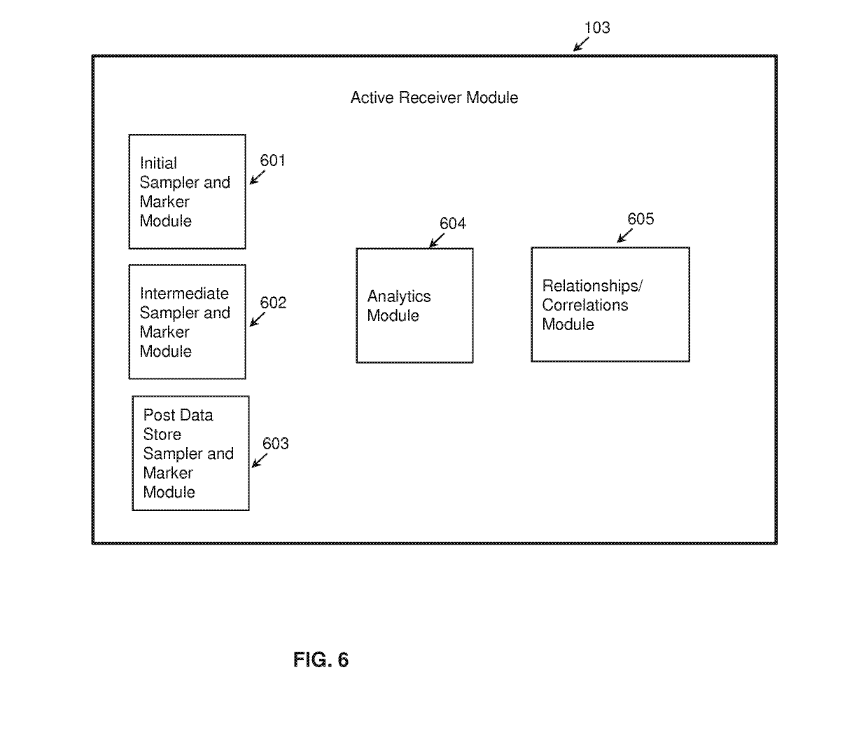

Turning to FIG. 6, example components of the active receiver module 103 are shown. The example components include an initial sampler and marker module 601, an intermediate sampler and marker module 602, a post-data-storage sampler and marker module 603, an analytics module 604, and a relationships/correlations module 605.

To facilitate real-time and efficient analysis of the obtained social data, different levels of speed and granularity are used to process the obtained social data. The module 601 is used first to initially sample and mark the obtained social data at a faster speed and lower sampling rate. This allows the active receiver module 103 to provide some results in real-time. The module 602 is used to sample and mark the obtained data at a slower speed and at a higher sampling rate relative to module 601. This allows the active receiver module 103 to provide more detailed results derived from module 602, although with some delay compared to the results derived from module 601. The module 603 samples all the social data stored by the active receiver module at a relatively slower speed compared to module 602, and with a much higher sampling rate compared to module 602. This allows the active receiver module 103 to provide even more detailed results which are derived from module 603, compared to the results derived from module 602. It can thus be appreciated, that the different levels of analysis can occur in parallel with each other and can provide initial results very quickly, provide intermediate results with some delay, and provide post-data-storage results with further delay.

The sampler and marker modules 601, 602, 603 also identify and extract other data associated with the social data including, for example: the time or date, or both, that the social data was published or posted; hashtags; a tracking pixel; a web bug, also called a web beacon, tracking bug, tag, or page tag; a cookie; a digital signature; a keyword; user and/or company identity associated with the social data; an IP address associated with the social data; geographical data associated with the social data (e.g. geo tags); entry paths of users to the social data; certificates; users (e.g. followers) reading or following the author of the social data; users that have already consumed the social data; etc. This data may be used by the active receiver module 103 and/or the social analytic synthesizer module 106 to determine relationships amongst the social data.

The analytics module 604 can use a variety of approaches to analyze the social data and the associated other data. The analysis is performed to determine relationships, correlations, affinities, and inverse relationships. Non-limiting examples of algorithms that can be used include artificial neural networks, nearest neighbor, Bayesian statistics, decision trees, regression analysis, fuzzy logic, K-means algorithm, clustering, fuzzy clustering, the Monte Carlo method, learning automata, temporal difference learning, apriori algorithms, the ANOVA method, Bayesian networks, and hidden Markov models. More generally, currently known and future known analytical methods can be used to identify relationships, correlations, affinities, and inverse relationships amongst the social data. The analytics module 604, for example, obtains the data from the modules 601, 602, and/or 603.

It will be appreciated that inverse relationships between two concepts, for example, is such that a liking or affinity to first concept is related to a dislike or repelling to a second concept.

The relationships/correlations module 605 uses the results from the analytics module to generate terms and values that characterize a relationship between at least two concepts. The concepts may include any combination of keywords, time, location, people, video data, audio data, graphics, etc.

The relationships module 605 can also identify keyword bursts. The popularity of a keyword, or multiple keywords, is plotted as a function of time. The analytics module identifies and marks interesting temporal regions as bursts in the keyword popularity curve. The analytics module identifies one or more correlated keywords associated with the keyword of interest (e.g. the keyword having a popularity burst). The correlated keyword is closely related to the keyword of interest at the same temporal region as the burst. Such a process is described in detail in U.S. patent application Ser. No. 12/501,324, filed on Jul. 10, 2009 and titled “Method and System for Information Discovery and Text Analysis”, the entire contents of which are incorporated herein by reference.

In another example aspect, the relationships module 605 can also identify relationships between topics (e.g. keywords) and users that are interested in the keyword. The relationships module, for example, can identify a user who is considered an expert in a topic. If a given user regularly comments on a topic, and there many other users who “follow” the given user, then the given user is considered an expert. The relationships module can also identify in which other topics that an expert user has an interest, although the expert user may not be considered an expert of those other topics. The relationships module can obtain a number of ancillary users that a given user follows; obtain the topics in which the ancillary users are considered experts; and associate those topics with the given user. It can be appreciated that there are various ways to correlate topics and users together. Further details are described in U.S. Patent Application No. 61/837,933, filed on Jun. 21, 2013 and titled “System and Method for Analysing Social Network Data”, the entire contents of which are incorporated herein by reference.

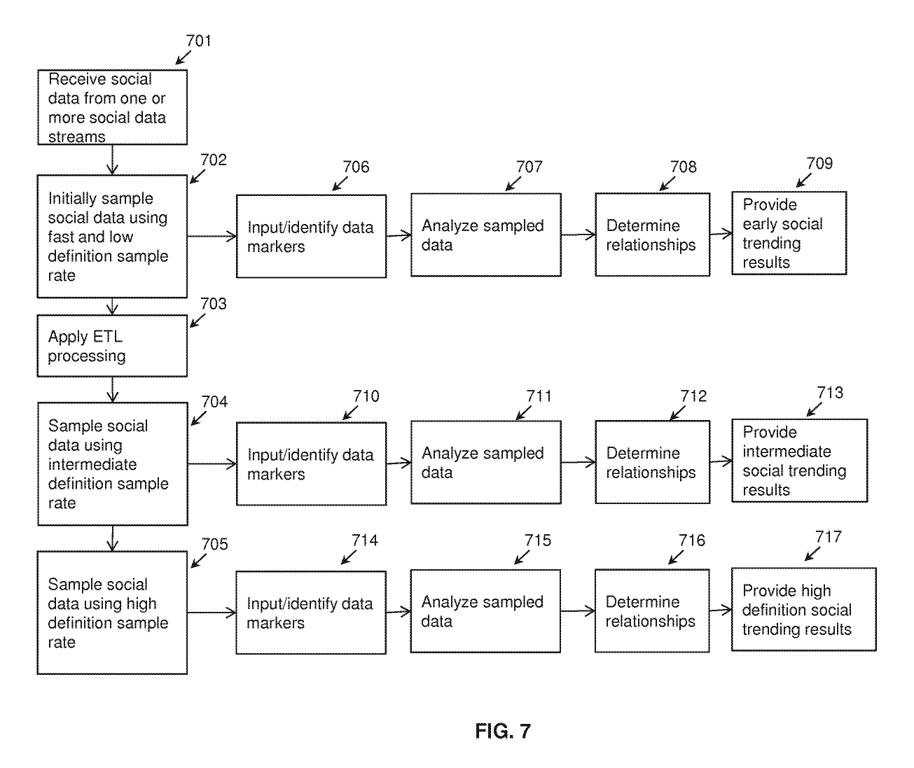

Turning to FIG. 7, example computer or processor implemented instructions are provided for receiving and analysing data according to the active receiver module 103. At block 701, the active receiver module receives social data from one or more social data streams. At block 702, the active receiver module initially samples the social data using a fast and low definition sample rate (e.g. using module 601). At block 703, the active receiver module applies ETL (Extract, Transform, Load) processing. The first part of an ETL process involves extracting the data from the source systems. The transform stage applies a series of rules or functions to the extracted data from the source to derive the data for loading into the end target. The load phase loads the data into the end target, such as the memory.

At block 704, the active receiver module samples the social data using an intermediate definition sample rate (e.g. using 601). At block 705, the active receiver module samples the social data using a high definition sample rate (e.g. using module 603). In an example embodiment, the initial sampling, the intermediate sampling and the high definition sampling are performed in parallel. In another example embodiment, the samplings occur in series.

Continuing with FIG. 7, after initially sampling the social data (block 702), the active receiver module inputs or identifies data markers (block 706). It proceeds to analyze the sampled data (block 707), determine relationships from the sampled data (block 708), and use the relationships to determine early or initial social trending results (block 709).

Similarly, after block 704, the active receiver module inputs or identifies data markers in the sampled social data (block 710). It proceeds to analyze the sampled data (block 711), determine relationships from the sampled data (block 712), and use the relationships to determine intermediate social trending results (block 713).

The active receiver module also inputs or identifies data markers in the sampled social data (block 714) obtained from block 705. It proceeds to analyze the sampled data (block 715), determine relationships from the sampled data (block 716), and use the relationships to determine high definition social trending results (block 717).

In an example embodiment, the operations at block 706 to 709, the operations at block 710 to 713, and the operations at block 714 to 717 occur in parallel. The relationships and results from blocks 708 and 709, however, would be determined before the relationships and results from blocks 712, 713, 716 and 717.

It will be appreciated that the data markers described in blocks 706, 710 and 714 assist with the preliminary analysis and the sampled data and also help to determine relationships. Example embodiments of data markers include keywords, certain images, and certain sources of the data (e.g. author, organization, location, network source, etc.). The data markers may also be tags extracted from the sampled data.

In an example embodiment, the data markers are identified by conducting a preliminary analysis of the sampled data, which is different from the more detailed analysis in blocks 707, 711 and 715. The data markers can be used to identify trends and sentiment.

In another example embodiment, data markers are inputted into the sampled data based on the detection of certain keywords, certain images, and certain sources of data. A certain organization can use this operation to input a data marker into certain sampled data. For example, a car branding organization inputs the data marker “SUV” when an image of an SUV is obtained from the sampling process, or when a text message has at least one of the words “SUV”, “Jeep”, “4×4”, “CR-V”, “Rav4”, and “RDX”. It can be appreciated that other rules for inputting data markers can be used. The inputted data markers can also be used during the analysis operations and the relationship determining operations to detect trends and sentiment.

Other example aspects of the active receiver module are provided below.

The active receiver module 103 is configured to capture, in real time, one or more electronic data streams.

The active receiver module 103 is configured to analyse, in real time, the social data relevant to a business.

The active receiver module 103 is configured to translate text from one language to another language.

The active receiver module 103 is configured to interpret video, text, audio and pictures to create business information. A non-limiting example of business information is sentiment information.

The active receiver module 103 is configured to apply metadata to the received social data in order to provide further business enrichment. Non-limiting examples of metadata include geo data, temporal data, business driven characteristics, analytic driven characteristics, etc.

The active receiver module 103 is configured to interpret and predict potential outcomes and business scenarios using the received social data and the computed information.

The active receiver module 103 is configured to propose user segment or target groups based upon the social data and the metadata received.

The active receiver module 103 is configured to proposed or recommend social data channels that are positively or negatively correlated to a user segment or a target group.

The active receiver module 103 is configured to correlate and attribute groupings, such as users, user segments, and social data channels. In an example embodiment, the active receiver module uses patterns, metadata, characteristics and stereotypes to correlate users, user segments and social data channels.

The active receiver module 103 is configured to operate with little or no human intervention.

The active receiver module 103 is configured to assign affinity data and metadata to the received social data and to any associated computed data. In an example embodiment, affinity data is derived from affinity analysis, which is a data mining technique that discovers co-occurrence relationships among activities performed by (or recorded about) specific individuals, groups, companies, locations, concepts, brands, devices, events, and social networks.

### Active Composer Module

The active composer module 104 is configured to analytically compose and create social data for communication to people. This module may use business rules and apply learned patterns to personalize content. The active composer module is configured, for example, to mimic human communication, idiosyncrasies, slang, and jargon. This module is configured to evaluate multiple social data pieces or objects composed by itself (i.e. module 104), and further configured to evaluate ranks and recommend an optimal or an appropriate response based on the analytics. Further, the active composer module is able to integrate with other modules, such as the active receiver module 103, the active transmitter module 105, and the social analytic synthesizer module 106. The active composer module can machine-create multiple versions of a personalized content message and recommend an appropriate, or optimal, solution for a target audience.

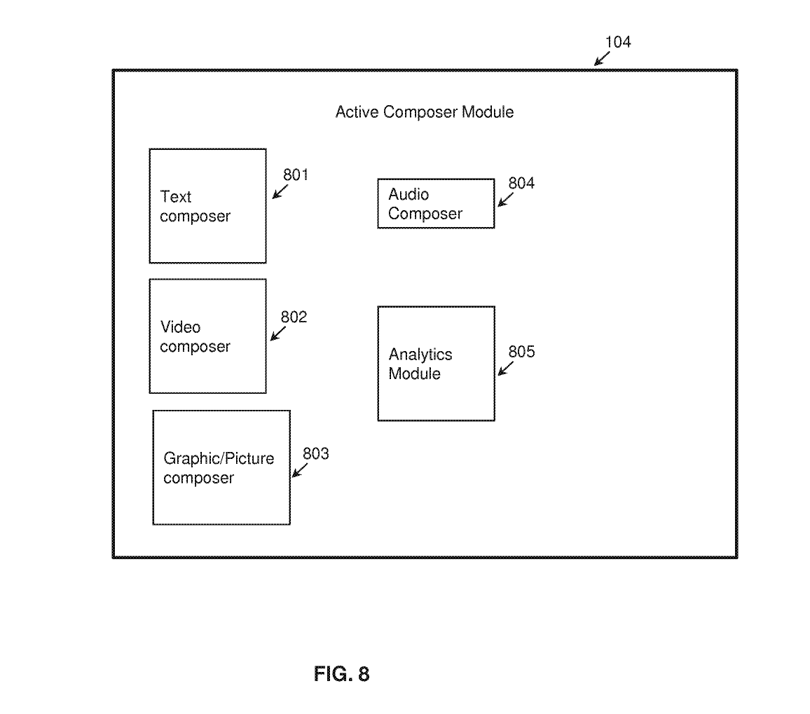

Turning to FIG. 8, example components of the active composer module 104 are shown. Example components include a text composer module 801, a video composer module 802, a graphics/picture composer module 803, an audio composer 804, and an analytics module 805. The composer modules 801, 802, 803 and 804 can operate individually to compose new social data within their respective media types, or can operate together to compose new social data with mixed media types.

The analytics module 805 is used to analyse the outputted social data, identify adjustments to the composing process, and generate commands to make adjustments to the composing process.

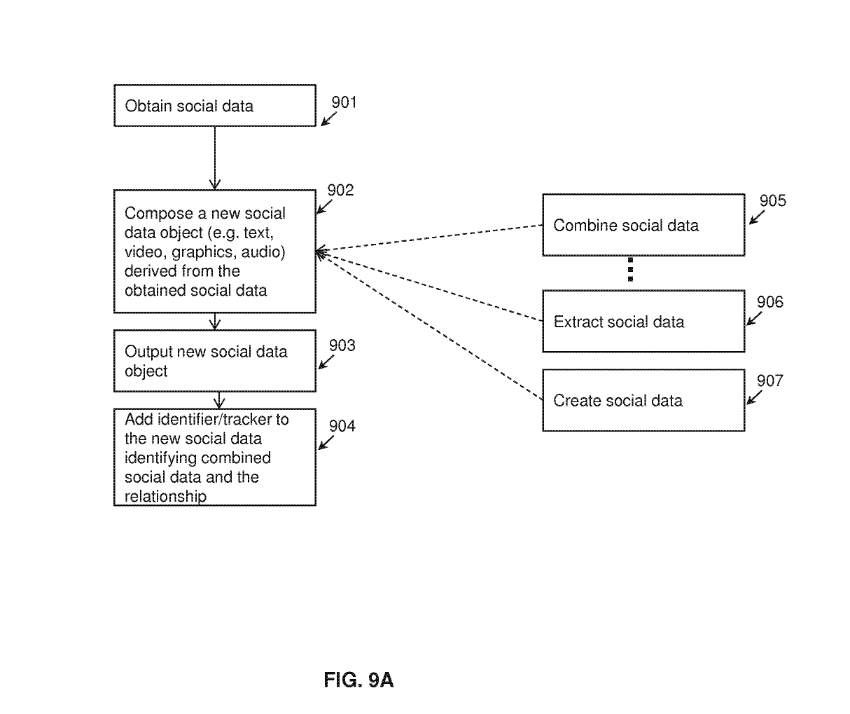

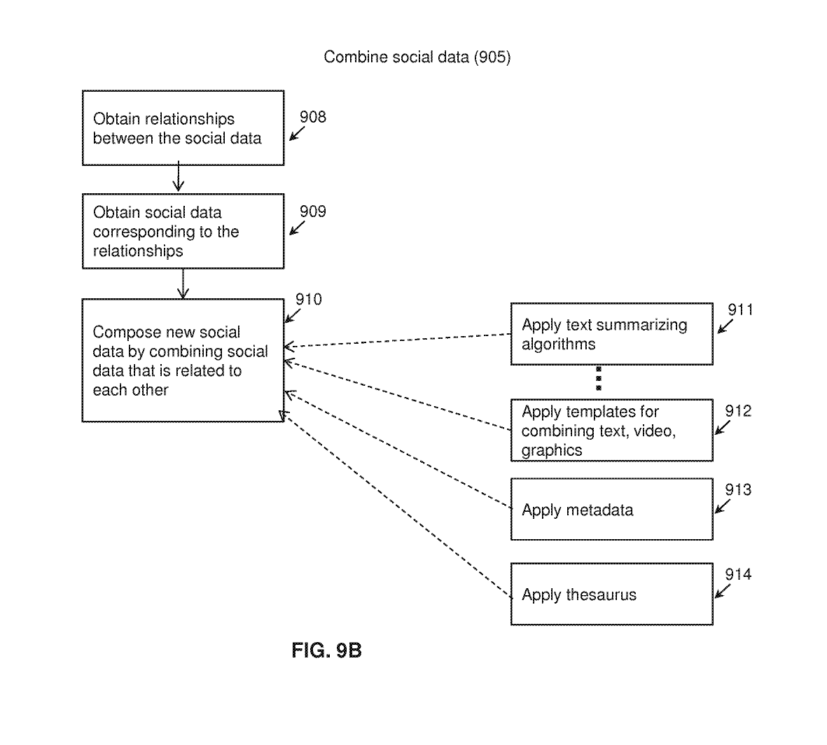

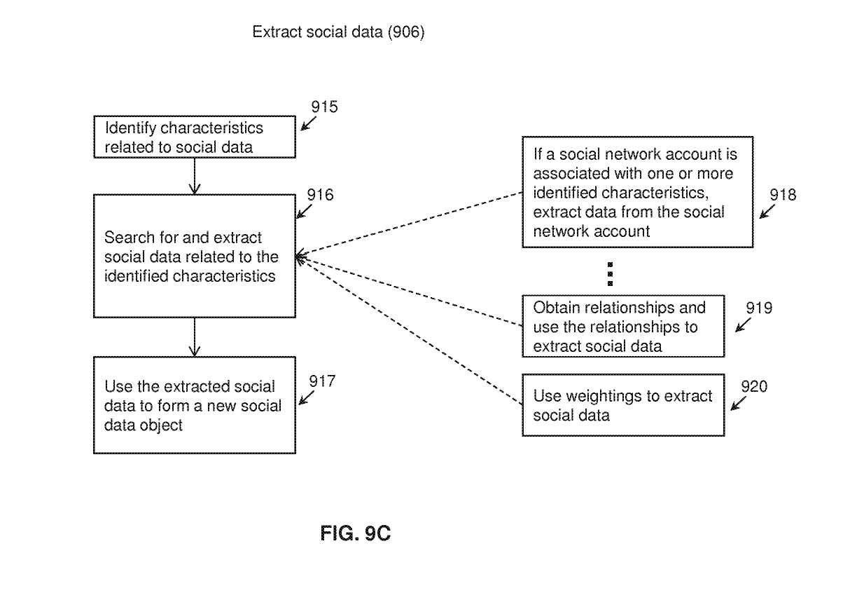

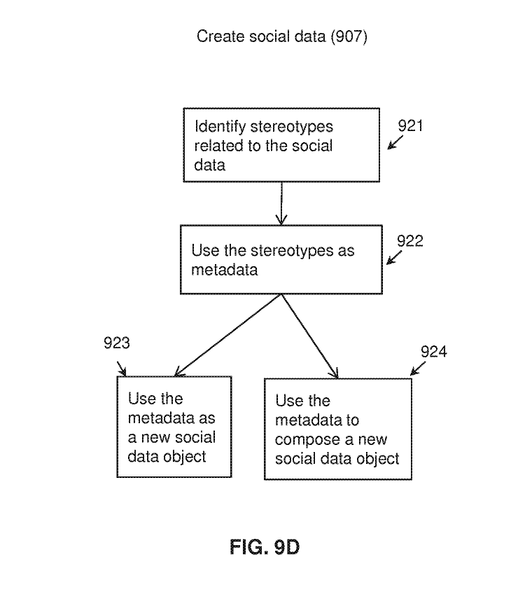

Turning to FIG. 9A, example computer or processor implemented instructions are provided for composing social data according the module 104. The active composer module obtains social data, for example from the active receiver module 103 (block 901). The active composer module then composes a new social data object (e.g. text, video, graphics, picture, photo, audio) derived from the obtained social data (block 902).

Various approaches can be used to compose the new social data object, or new social data objects. For example, social data can be combined to create the new social data object (block 905), social data can be extracted to create the new social object (block 906), and new social data can be created to form the new social data object (block 907). The operations from one or more of blocks 905, 906 and 907 can be applied to block 902. Further details in this regard are described in FIGS. 9B, 9C and 9D.

Continuing with FIG. 9A, at block 903, the active composer module outputs the composed social data. The active composer module may also add identifiers or trackers to the composed social data, which are used to identify the sources of the combined social data and the relationship between the combined social data.

Turning to FIG. 9B, example computer or processor implemented instructions are provided for combining social data according to block 905. The active composer module obtains relationships and correlations between the social data (block 908). The relationships and correlations, for example, are obtained from the active receiver module. The active composer module also obtains the social data corresponding to the relationships (block 909). The social data obtained in block 909 may be a subset of the social data obtained by the active receiver module, or may be obtained by third party sources, or both. At block 910, the active composer module composes new social data (e.g. a new social data object) by combining social data that is related to each other.

It can be appreciated that various composition processes can be used when implementing block 910. For example, a text summarizing algorithm can be used (block 911). In another example, templates for combining text, video, graphics, etc. can be used (block 912). In an example embodiment, the templates may use natural language processing to generate articles or essays. The template may include a first section regarding a position, a second section including a first argument supporting the position, a third section including a second argument supporting the position, a fourth section including a third argument supporting the position, and a fifth section including a summary of the position. Other templates can be used for various types of text, including news articles, stories, press releases, etc.

Natural language processing catered to different languages can also be used. Natural language generation can also be used. It can be appreciated that currently know and future known composition algorithms that are applicable to the principles described herein can be used.

Natural language generation includes content determination, document structuring, aggregation, lexical choice, referring expression generation, and realisation. Content determination includes deciding what information to mention in the text. In this case the information is extracted from the social data associated with an identified relationship. Document structuring is the overall organisation of the information to convey. Aggregation is the merging of similar sentences to improve readability and naturalness. Lexical choice is putting words to the concepts. Referring expression generation includes creating referring expressions that identify objects and regions. This task also includes making decisions about pronouns and other types of anaphora. Realisation includes creating the actual text, which should be correct according to the rules of syntax, morphology, and orthography. For example, using “will be” for the future tense of “to be”.

Continuing with FIG. 9B, metadata obtained from the active receiver module, or obtained from third party sources, or metadata that has been generated by the system 102, may also be applied when composing the new social data object (block 913). Furthermore, a thesaurus database, containing words and phrases that are synonymous or analogous to keywords and key phrases, can also be used to compose the new social data object (block 914). The thesaurus database may include slang and jargon.

Turning to FIG. 9C, example computer or processor implemented instructions are provided for extracting social data according to block 906. At block 915, the active composer module identifies characteristics related to the social data. These characteristics can be identified using metadata, tags, keywords, the source of the social data, etc. At block 916, the active composer module searches for and extracts social data that is related to the identified characteristics.

For example, one of the identified characteristics is a social network account name of a person, an organization, or a place. The active composer module will then access the social network account to extract data from the social network account. For example, extracted data includes associated users, interests, favourite places, favourite foods, dislikes, attitudes, cultural preferences, etc. In an example embodiment, the social network account is a LinkedIn account or a Facebook account. This operation (block 918) is an example embodiment of implementing block 916.

Another example embodiment of implementing block 916 is to obtain relationships and use the relationships to extract social data. Relationships can be obtained in a number of ways, including but not limited to the methods described herein. Another example method to obtain a relationship is using Pearson's correlation. Pearson's correlation is a measure of the linear correlation (dependence) between two variables X and Y, giving a value between +1 and −1 inclusive, where 1 is total positive correlation, 0 is no correlation, and −1 is negative correlation. For example, if given data X, and it is determined X and data Y are positively correlated, then data Y is extracted.

Another example embodiment of implementing block 916 is to use weighting to extract social data (block 920). For example, certain keywords can be statically or dynamically weighted based on statistical analysis, voting, or other criteria. Characteristics that are more heavily weighted can be used to extract social data. In an example embodiment, the more heavily weighted a characteristic is, the wider and the deeper the search will be to extract social data related to the characteristic.

Other approaches for searching for and extracting social data can be used.

At block 917, the extracted social data is used to form a new social data object.

Turning to FIG. 9D, example computer or processor implemented instructions are provided for creating social data according to block 907. At block 921, the active composer module identifies stereotypes related to the social data. Stereotypes can be derived from the social data. For example, using clustering and decision tree classifiers, stereotypes can be computed.

In an example stereotype computation, a model is created. The model represents a person, a place, an object, a company, an organization, or, more generally, a concept. As the system 102, including the composer module, gains experience obtaining data and feedback regarding the social communications being transmitted, the active composer module is able to modify the model. Features or stereotypes are assigned to the model based on clustering. In particular, clusters representing various features related to the model are processed using iterations of agglomerative clustering. If certain of the clusters meet a predetermined distance threshold, where the distance represents similarity, then the clusters are merged. For example, the Jaccard distance (based on the Jaccard index), a measure used for determining the similarity of sets, is used to determine the distance between two clusters. The cluster centroids that remain are considered as the stereotypes associated with the model. For example, the model may be a clothing brand that has the following stereotypes: athletic, running, sports, swoosh, and ‘just do it’.

In another example stereotype computation, affinity propagation is used to identify common features, thereby identifying a stereotype. Affinity propagation is a clustering algorithm that, given a set of similarities between pairs of data points, exchanges messages between data points so as to find a subset of exemplar points that best describe the data. Affinity propagation associates each data point with one exemplar, resulting in a partitioning of the whole data set into clusters. The goal of affinity propagation is to minimize the overall sum of similarities between data points and their exemplars. Variations of the affinity propagation computation can also be used. For example, a binary variable model of affinity propagation computation can be used. A non-limiting example of a binary variable model of affinity propagation is described in the document by Inmar E. Givoni and Brendan J. Frey, titled “A Binary Variable Model of Affinity Propagation”, Neural Computation 21, 1589-1600 (2009), the entire contents of which are hereby incorporated by reference.

Another example stereotype computation is Market Basket Analysis (Association Analysis), which is an example of affinity analysis. Market Basket Analysis is a mathematical modeling technique based upon the theory that if you buy a certain group of products, you are likely to buy another group of products. It is typically used to analyze customer purchasing behavior and helps in increasing the sales and maintain inventory by focusing on the point of sale transaction data. Given a dataset, an apriori algorithm trains and identifies product baskets and product association rules. However, the same approach is used herein to identify characteristics of a person (e.g. stereotypes) instead of products. Furthermore, in this case, users' consumption of social data (e.g. what they read, watch, listen to, comment on, etc.) is analyzed. The apriori algorithm trains and identifies characteristic (e.g. stereotype) baskets and characteristic association rules.

Other methods for determining stereotypes can be used.

Continuing with FIG. 9D, the stereotypes are used as metadata (block 922). In an example embodiment, the metadata is the new social data object (block 923), or the metadata can be used to derive or compose a new social data object (block 924).

It can be appreciated that the methods described with respect to blocks 905, 906 and 907 to compose a new social data object can be combined in various way, though not specifically described herein. Other ways of composing a new social data object can also be applied.

In an example embodiment of composing a social data object, the social data includes the name “Chris Farley”. To compose a new social data object, social data is created using stereotypes. For example, the stereotypes ‘comedian’, ‘fat’, ‘ninja’, and ‘blonde’ are created and associated with Chris Farley. The stereotypes are then used to automatically create a caricature (e.g. a cartoon-like image of Chris Farley). The image of the person is automatically modified to include a funny smile and raised eye brows to correspond with the ‘comedian’ stereotype. The image of the person is automatically modified to have a wide waist to correspond with the ‘fat’ stereotype. The image of the person is automatically modified to include ninja clothing and weaponry (e.g. a sword, a staff, etc.) to correspond with the ‘ninja’ stereotype. The image of the person is automatically modified to include blonde hair to correspond with the ‘blonde’ stereotype. In this way, a new social data object comprising the caricature image of Chris Farley is automatically created. Various graphic generation methods, derived from text, can be used. For example, a mapping database contains words that are mapped to graphical attributes, and those graphical attributes in turn can be applied to a template image. Such a mapping database could be used to generate the caricature image.

In another example embodiment, the stereotypes are used to create a text description of Chris Farley, and to identify in the text description other people that match the same stereotypes. The text description is the composed social data object. For example, the stereotypes of Chris Farley could also be used to identify the actor “John Belushi” who also fits the stereotypes of ‘comedian’ and ‘ninja’. Although the above examples pertain to a person, the same principles of using stereotypes to compose social data also apply to places, cultures, fashion trends, brands, companies, objects, etc.

The active composer module 104 is configured to operate with little or no human intervention.

### Active Transmitter Module

The active transmitter module 105 analytically assesses preferred or appropriate social data channels to communicate the newly composed social data to certain users and target groups. In one aspect, the active transmitter module 105 also assesses the preferred time to send or transmit the newly composed social data.

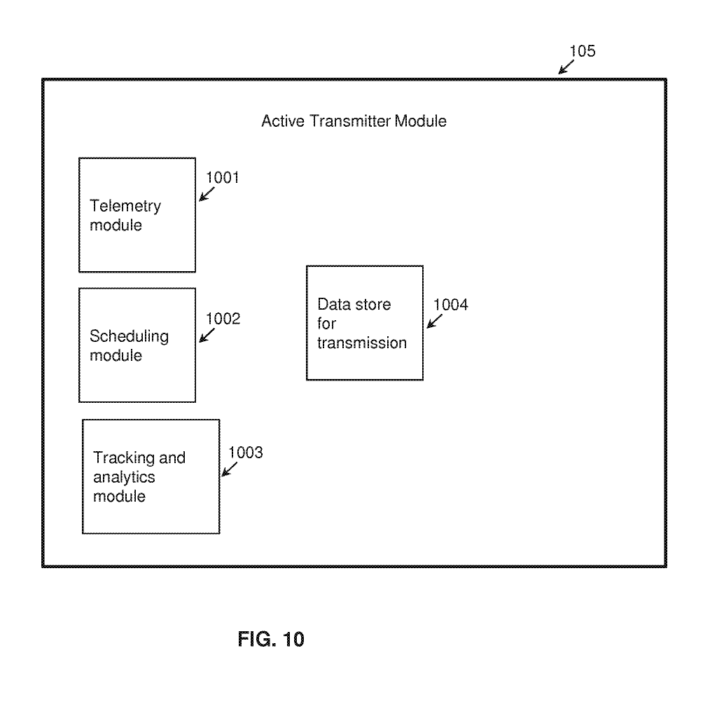

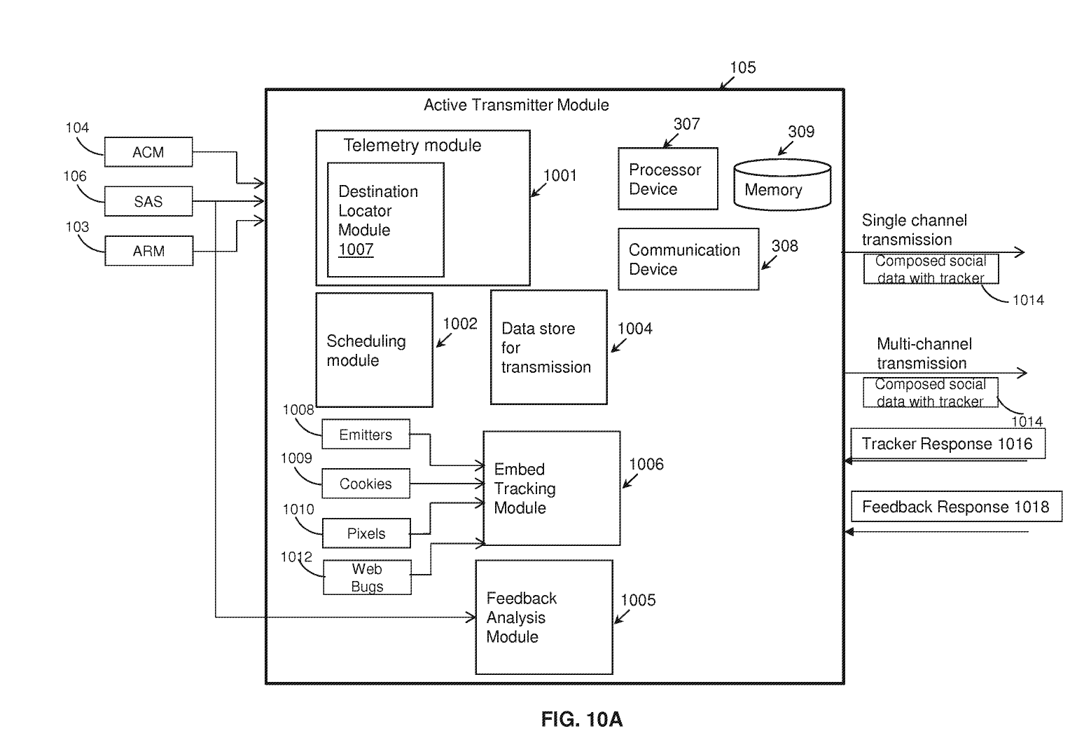

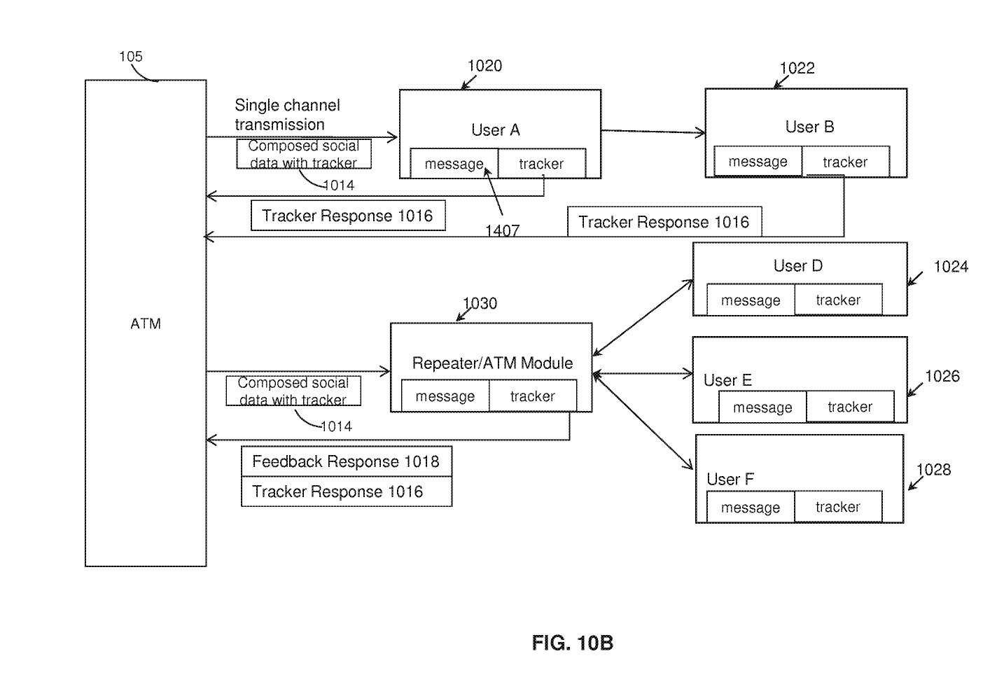

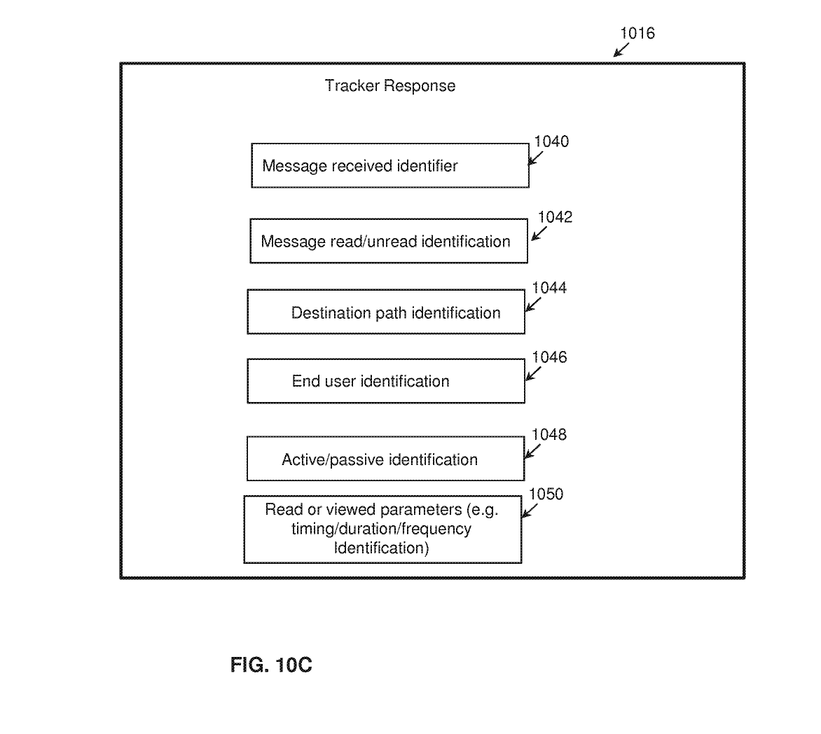

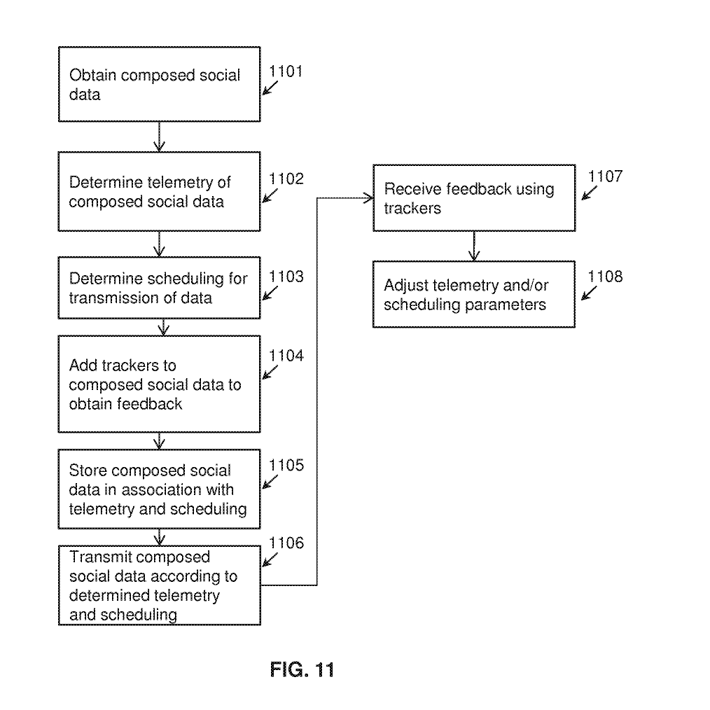

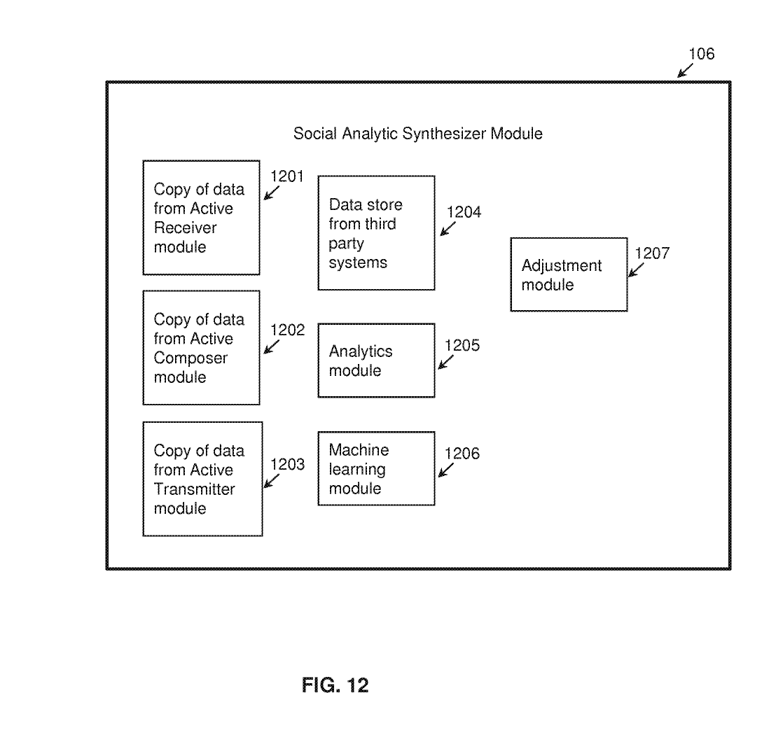

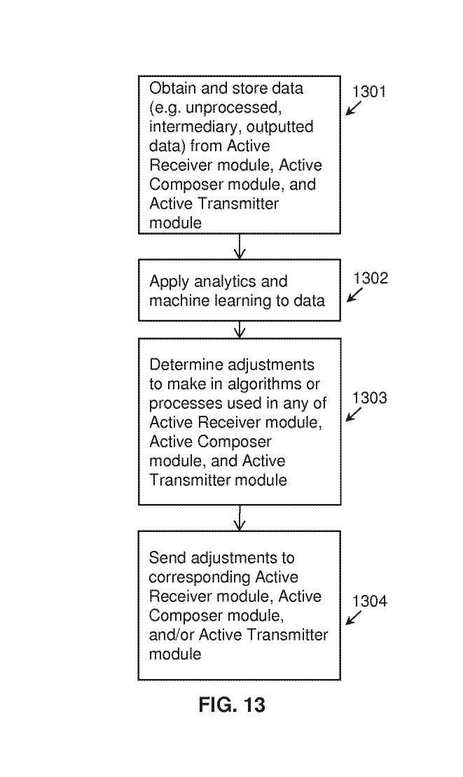

Turning to FIG. 10, example components of the active transmitter module 105 are shown. Example components include a telemetry module 1001, a scheduling module 1002, a tracking and analytics module 1003, and a data store for transmission 1004. The telemetry module 1001 is configured to determine or identify over which social data channels a certain social data object should be sent or broadcasted. A social data object may be a text article, a message, a video, a comment, an audio track, a picture, a photo, a graphic, or a mixed-media social piece. For example, a social data object about a certain car brand should be sent to websites, RSS feeds, video or audio channels, blogs, or groups that are viewed or followed by potential car buyers, current owners of the car brand and past owners of the car brand. The scheduling module 1002 determines a preferred time range or date range, or both, for sending a composed social data object. For example, if a newly composed social data object is about stocks or business news, the composed social data object will be scheduled to be sent during working hours of a work day. The tracking and analytics module 1003 inserts data trackers or markers into a composed social data object to facilitate collection of feedback from people. Data trackers or markers include, for example, tags, feedback (e.g. like, dislike, ratings, thumb up, thumb down, etc.), number of views on a web page, etc.

The data store for transmission 1004 stores a social data object that has the associated data tracker or marker. The social data object may be packaged as a “cart”. Multiple carts, having the same social data object or different social data objects, are stored in the data store 1004. The carts are launched or transmitted according to associated telemetry and scheduling parameters. The same cart can be launched multiple times. One or more carts may be organized under a campaign to broadcast composed social data. The data trackers or markers are used to analyse the success of a campaign, or of each cart.

### Exemplary Components of Active Transmitter Module

Referring to FIG. 10A, shown is a further exemplary components of the active transmitter module 105 depicting further components for processing the social data. Referring to FIG. 10A, the active transmitter module 105 further comprises a destination locator module 1007 for determining target destination(s) of social data messages, a scheduling module 1002 for determining scheduling of social data messages being transmitted; an embed tracking module 1006 for embedding trackers (also referred to as markers herein) for tracking how well a message was received; and a feedback analysis module 1005 for analyzing feedback 1016 and/or tracker responses 1018 received from one or more destination targets or other active transmitter modules in communication with an instance of the active transmitter module 105. The embed tracking module 1006 is configured to embed one or more types of trackers within the social data to transmit as composed social data with tracker 1014 to a single channel transmission or to multiple channels as shown in FIG. 10A.

In one aspect, the active transmitter module 105, could further incorporate third party pixels, emitters, trackers to use within the system and modify to define that a message was seen or clicked upon by an end user (e.g. a customer). Upon receiving the feedback, the active transmitter module 105 and/or the synthesizer module 106 would be configured to use the third party feedback to further bias or adjust the operation of the active transmitter module 105 and adjust subsequent transmission of social data messages (e.g. adjust where, who, when, . . . ) receive the transmitted messages based on the third party telemetry in addition to the systems described herein for utilizing the feedback to optimize future transmission behaviour as defined by the active transmitter module 105 (e.g. as defining location, time of transmission, duration, end user(s), length of viewing time, allowability to retransmit the social data message to other parties . . . ). The allowability can define for example, permissions for re-transmitting the social data from one target to another target (e.g. retweeting the message or sharing the message). As discussed herein, the feedback from the pixels, trackers and/or emitters is used, in one embodiment, to generate new social data content that is calculated by the synthesizer module 106 and/or the transmitter module 105 to be relevant to the end user based on prior success and feedback. In another aspect, the subsequent social data content generated by the system is adjusted and redirected according to new transmission parameters (e.g. location, destination, duration . . . ) based on patterns and correlations from the received feedback.

In yet a further aspect, the active transmitter module 105 and the synthesizer module 106 could, singularly or in combination, transmit user tracker information to other Internet companies and sites, including ad exchanges, which in turn, can track the user's prior Internet journey and interest, and then subsequently provide relevant messages and/or ads, for example for a pre-defined duration of time thereafter.

In one aspect, the content of the social data 1014 may be composed by the active composer module 104 and sent to a specific channel. Furthermore, the social data 1014 may define that within each channel, the social data 1014 is to be transmitted to selective sub segment of users (e.g. as defined within transmission parameters of the social data 1014).

In another aspect, the social data 1014 may be provided to multiple simultaneous channels (e.g. social networking sites, forums, blogs . . . ). In another aspect, the active transmitter module 105 may be configured to communicate with the synthesizer module 106 for optimizing the transmission of the social data 1014.

For example, if a response is received from one or more users (e.g. tracker response 1016) that indicates that the social data content resonated with a particular group of people then subsequent social data of similar content would be optimized for transmitting to the same particular group of people. Alternatively, the feedback response 1018 and/or trackers 1016 can indicate that more positive feedback was received at one social channel versus another (e.g. FaceBook vs. Twitter) and thus the active transmitter module 105 (e.g. via the feedback analysis module 1005) and/or the synthesizer module 106 is configured to reroute subsequent message to the channel associated with the positive feedback.

As defined earlier, the active transmitter module 105 can also incorporate third party pixels, emitters, trackers etc. to provide the third party verification that a message was seen or clicked upon by a customer. The synthesizer module 106 could, alternatively incorporate the feedback from third party tracking, and use this third party feedback to bias and/or adjust the active transmitter module 105 (and corresponding transmission parameters as described herein), and ultimately adjust where, when, who, etc. see a transmitted message based using the third party transmission telemetry.

Trackers

In one embodiment illustrated, the types of trackers comprise emitters 1008, cookies 1009, pixels 1010, and web bugs 1012.

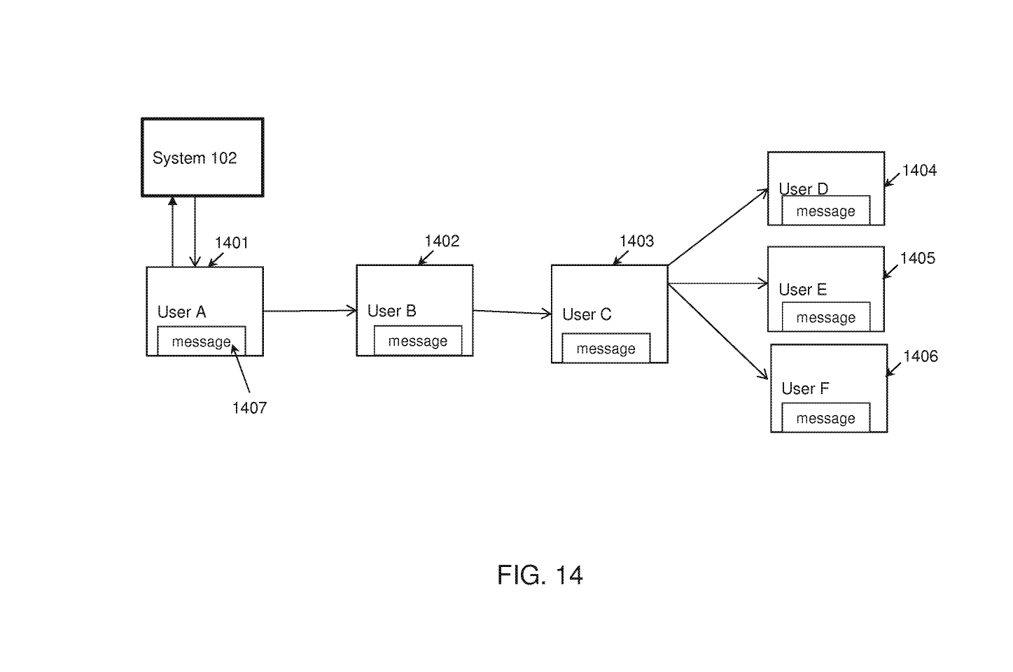

In one aspect, the different types of trackers can be combined together. The trackers can provide information on for example, how many people visited a particular website associated with the social data, how many people read the social data, and how many people clicked through or forwarded the social data. Specific components of trackers are provided with respect to FIG. 100.

Preferably, the trackers are seamlessly integrated by the embed tracking module 1006 within the social data (e.g. text, video, pictures or photos, graphics, and/or audio data, or combinations thereof) such as to allow users to receive a tracker response 1016 that tracks the activity and popularity of the social data tracker such as to provide metrics that are useful in modifying and improving the behaviour of the active transmitter module 105 for transmitting subsequent messages.

Emitters 1008

In one aspect, emitters 1008 are simply referred to digital code embedded within the composed social data message 1014 (e.g. text, video, pictures, photos, graphics, and audio data, or combinations thereof) that provide an emitter response to the active transmitter module 105 for each destination or hop which the social data travels.

Cookies 1009

A cookie is a digital software code that is used to track an internet users' web browsing activities. For example, if a user selects an advertisement on a website (e.g. generated by the social data 1014) the active transmitter module 105 will be provided in the form of the tracker response 1016, the browsing history of the user across all sites that are associated with the social data 1014. In a further aspect, the tracker response 1016 can include the browsing history of the user with respect to all sites associated with the source of the social data (e.g. advertiser). The cookies 1009 as provided in the tracker response 1016 can also provide information on the web pages the user has visited associated with the social data 1014, in what sequence and for how long. In one aspect, the tracker further utilizes finger printing such that the user's identity endures even if the cookies 1009 are deleted.

Tracking Pixels 1010

Tracking pixels 1010 are typically a small (e.g. 1×1 pixel size), invisible to the eye pixel, preferably inserted within a social data having and image or a video segment that allows tracking website visits, email tracking, and other types of communication activity on the Internet. As will be understood to a person skilled in the art, an invisible to the eye pixel refers to a pixel that is camouflaged or hidden within an image or video of the social data such as to not distort the image or social data carrying the tracking pixel 1010. Similarly a tracking pixel could be hidden within a text message or an email message such as to remain hidden. In one aspect, the tracking pixel 1010 once embedded within a social data message remains hidden and the sending of the pixel back to its originator (e.g. the active transmitter module 106) is a process that is automatically performed without user involvement. The pixel can be sent back in the form of the tracker response 1016.

Tracking pixels 1010 can be defined as software code contained in typically a single clear/invisible pixel (e.g. a .gif format) that tracks the social data messages 1014 as it goes anywhere online.

Web Bugs 1012

A web bug is a digital object embedded within a web page or a mailing list, or a forum, or an email associated with the social data (e.g. social network site) and it is usually invisible to the user but allows checking that a user has viewed the page or email. The social data displayed on the website or mailing list or forum or email can be in the form of text, video, pictures, photos, graphics, and/or audio data, or combinations thereof. The web bug can be used for example for email tracking and page tagging for web analytics. As will be understood by a person skilled in the art, alternative names such as a web beacon, tracking bug, tag, or page tag are also used in the art to refer to the web bugs 1012. The web bug 1012 when provided by the tracker response 1016 can reveal for example, who is reading a web page (e.g. social network site), or email, or forum containing the social data message (e.g. posted on a social networking site). In accordance with one embodiment, the web bugs 1012 can also be used to determine whether a social data message was read or forwarded elsewhere, or reposted. The web bug 1012 in one aspect, tracks the IP address of the computer receiving and/or reading the social data message, the time the content was received and/or reviewed, the type of user that made the request for viewing the social data 1014. The active transmitter module 105 can then store this information as received by 1016 and associate it with a unique tracking token attached to the originated message (e.g. social data 1014).

In accordance with yet another embodiment, the tracker 1014 can contain a trigger that causes end users receiving the social data message to collect and provide feedback from the end users (e.g. target recipients) regarding the social data message 1014. The feedback response 1018 can include real time engagement metrics (e.g. click through rates, frequency) that are fed back to the active transmitter module 105 and/or synthesizer (SAS) module 106. The feedback response can include information regarding velocity and frequency of these engagement metrics (real time, near real time) for subsequent use to alter the telemetry (location, time of day, frequency, content) of the delivered content (e.g. social data 1014) via the feedback analysis module 1005.

Referring again to FIG. 10A, the feedback analysis module 1005 is configured to receive tracker response 1016 and feedback response 1018 from end users, other servers in communication with the active transmitter module 105 and/or other active transmitter modules that communicate with the recipients. The feedback analysis module 1005 thus receives data relating to the social data 1014 including but not limited to: identification of users receiving the message (e.g. IP address), identification of initial recipients and subsequent recipients (e.g. forwards, re-tweets), engagement metrics, timing of receipt of message, duration read or viewed, number of times read or viewed, click-through rate and frequency, identification of locations (e.g. geographical locations) and languages associated with the social data (e.g. in which the social data was read/viewed or forwarded in or feedback language). As discussed earlier, based on the tracker response 1016 and/or feedback response 1018, the feedback analysis module communicated with the processor 307 for instructing the active transmitter module 105 to modify parameters of subsequent social data 1014 transmission to improve feedback and receptiveness of social data. For example, if the tracker response and/or feedback response 1016, 1018 reveal that social data message having a particular type or content is received more positively (e.g. click through rate or duration read or viewed or frequency of forwards) on a particular day and within a certain time of day, then the feedback analysis module 1005 deciphers this information and causes the active transmitter module 105 to transmit subsequent social data having a similar type or content within the certain time of day and on said particular day (e.g. via scheduling module 1002). Additionally, the feedback analysis module 1005 is configured to communicate with the synthesizer module 106 for receiving feedback from other modules (e.g. active composer module 104, and/or active receiver module 103) and affect the parameters (e.g. destination, timing, duration, language) for transmitting the social data 1014.

The feedback analysis module 1005 can be configured to utilize pattern learning algorithms for analyzing the feedback and/or tracker responses and determining optimization patterns. Non-limiting examples of algorithms for implementing the analysis on the tracker and/or feedback responses by module 1005 can include artificial neural networks, nearest neighbor, Bayesian statistics, decision trees, regression analysis, fuzzy logic, K-means algorithm, clustering, fuzzy clustering, the Monte Carlo method, learning automata, temporal difference learning, apriori algorithms, the ANOVA method, Bayesian networks, and hidden Markov models. More generally, currently known and future known analytical methods can be used to identify relationships, correlations, affinities, and inverse relationships amongst the feedback and tracker responses for the social data 1014.

Exemplary Communication Flow of Information from the Active Transmitter Module

Referring to FIG. 10B, shown in a schematic illustrating exemplary communication between an active transmitter module 105 and external recipients of the social data 1014. In one example, the social data 1014 is transmitter to User A 1020, the combined message and tracker 1407 is displayed (e.g. text, video and/or audio) to User A 1020. User A 1020 then forwards this social data message 1407 to User B 1022. The information identifying User A, time and duration of receipt/viewing of message, forwarding of message to User B 1022 is sent from User A 1020 as the tracker response 1016 to the active transmitter module 105. Additionally, a second tracker response 1016 is sent from User B 1022 identifying User B 1022 information (e.g. IP address, user name) and whether the message was received positively (e.g. click through rate, when viewed or read). The tracker response 1016 can be implemented with cookies, emitters, pixels, web bugs or other mechanisms described herein. In this aspect, User A 1020 and User B 1022 may be configured to provide updates along the way while the social data message is distributed. In this configuration, the active transmitter module 105 is configured to track the message from central server to distribution servers to each of the different customers (e.g. tracking each of the intermediary steps) such as to obtain full information on where the message has been and the estimated time for arrival at the destination.

Although two users have been shown in FIG. 10B as user A and user B, as can be envisaged, this communication can be expanded to N users. Furthermore, although a specific flow of information is shown in FIG. 10B, this is not limiting and other flows of information could be envisaged for communicating and sharing the social data message across multiple communication channels and destinations. For example, the message could stop at user A. Alternatively, user A could communicate to user B and the message could stop there. Further alternatively, user A could communicate to a number of users in addition to user B. In another aspect, the users which A communicates with could in turn communicate/retransmit/repost the message (e.g. retweet) the message to one or more other users. Accordingly, the schematic in FIG. 10B is exemplary and not limiting.

Referring again to FIG. 10B, in another example, the composed social data with embedded tracker 1014 is sent to a repeater module or another active transmitter module 1030. In this scenario, the message is then broadcast to multiple users (User D 1024, User E 1026, and User F 1028). The trackers in each of the messages received by User D, User E and User F may be configured to communicate with their local repeater/ATM Module 1030 which then consolidates the tracker responses 1016 and any feedback responses 1018 received from multiple associated users and send them to the active transmitter module 105 to modify the transmission parameters (e.g. transmission targets or scheduling) for improving the feedback and visibility of subsequent social data messages 1014.

Generally, a repeater module as referred to herein is configured similar to the active transmitter module 105 but to repeat and retransmit a message intended for a first user to other users based upon feedback received. In the example shown in FIG. 10B, User B 1022 can provide feedback via tracker response 1016 that the message is well received within a certain social networking site. The repeater module 1030 may then be configured to repeat the social data to multiple users within that certain social networking site.

Referring to FIG. 100, shown are exemplary components of the tracker response 1016. The tracker response 1016 comprises a message received identifier 1040, a message read/unread identification 1042, a destination path identification 1044 (e.g. path travelled and number of hops taken), end user identification 1046 (e.g. for each user that has viewed, read or forwarded the social data 1014), active/passive identification 1048 (whether the message was actively or passively viewed), read or viewed parameters 1050 (timing/duration/frequency identification). Passive transmission can indicate that a social data object was received at the intended recipient target. Active transmission can indicate that the transmission was received and further exposed to a number of additional users that were not original recipients of the message. Referring to end user identification module 1046, this could include for example, a social user (e.g. a member of a social data network or channel). In one example, the social user has other social identity names or handles on the Internet associated with them (e.g. associated with different social data websites). For example, these can include, useralias@twitter.com for Twitter; user name for Facebook, etc. . . . Accordingly, in one aspect, the active transmitter module is further configured to comprise a matching algorithm module for associating various alias names and user identification handles with one another such as to help derive social names and/or other related social names. In a further aspect, the active transmitter module is further configured to store the various alias names and identities in a database (e.g. a social customer master record database) to associate further feedback with the same user.

Turning to FIG. 11, example computer or processor implemented instructions are provided for transmitting composed social data according the active transmitter module 105. At block 1101, the active transmitter module obtains the composed social data. At block 1102, the active transmitter module determines the telemetry of the composed social data. At block 1103, the active transmitter module determines the scheduling for the transmission of the composed social data. Trackers, which are used to obtain feedback, are added to the composed social data (block 1104), and the social data including the trackers are stored in association with the scheduling and telemetry parameters (block 1105). At the time determined by the scheduling parameters, the active transmitter module sends the composed social data to the identified social data channels, as per the telemetry parameters (block 1106).

Continuing with FIG. 11, the active transmitter module receives feedback using the trackers (block 1107) and uses the feedback to adjust telemetry or scheduling parameters, or both (block 1108).

Other example aspects of the active transmitter module 105 are provided below.

The active transmitter module 105 is configured to transmits messages and, generally, social data with little or no human intervention

The active transmitter module 105 is configured to use machine learning and analytic algorithms to select one or more data communication channels to communicate a composed social data object to an audience or user(s). The data communication channels include, but are not limited to, Internet companies such as FaceBook, Twitter, and Bloomberg. Channel may also include traditional TV, radio, and newspaper publication channels.

The active transmitter module 105 is configured to automatically broaden or narrow the target communication channel(s) to reach a certain target audience or user(s).

The active transmitter module 105 is configured to integrate data and metadata from third party companies or organizations to help enhance channel targeting and user targeting, thereby improving the effectiveness of the social data transmission. As described earlier, the third party data can include third party pixels, emitters, trackers, etc. for providing verification that a message was seen or clicked upon by an end user (e.g. target destination). As described earlier, the synthesizer module 106 uses the third party feedback to bias and/or adjust the transmission of social data messages based on the third party transmission telemetry and further analysis/correlation from the received feedback data.

The active transmitter module 105 is configured to apply and transmit unique markers to track composed social data. The markers track the effectiveness of the composed social data, the data communication channel's effectiveness, and ROI (return on investment) effectiveness, among other key performance indicators.

The active transmitter module 105 is configured to automatically recommend the best time or an appropriate time to send/transmit the composed social data.

The active transmitter module 105 is configured to listen and interpret whether the composed social data was successfully received by the data communication channel(s), or viewed/consumer by the user(s), or both.

The active transmitter module 105 is configured to analyse the user response of the composed social data and automatically make changes to the target channel(s) or user(s), or both. In an example, the decision to make changes is based on successful or unsuccessful transmission (receipt by user).

The active transmitter module 105 is configured to filter out certain data communication channel(s) and user(s) for future or subsequent composed social data transmissions.

The active transmitter module 105 is configured to repeat the transmission of previously sent composed social data for N number of times depending upon analytic responses received by the active transmitter module. The value of N in this scenario may be analytically determined.

The active transmitter module 105 is configured to analytically determine duration of time between each transmission campaign.

The active transmitter module 105 is configured to apply metadata from the active composer module 104 to the transmission of the composed social data, in order to provide further business information enrichment. The metadata includes, but is not limited to, geo data, temporal data, business driven characteristics, unique campaign IDs, keywords, hash tags or equivalents, analytic driven characteristics, etc.

The active transmitter module 105 is configured to scale in size, for example, by using multiple active transmitter modules 105. In other words, although one module 105 is shown in the figures, there may be multiple instances of the same module to accommodate large scale transmission of data.

Active Transmitter Module and Prediction

In one embodiment, the active transmitter module 105 is configured to predict the success of a social data message as transmitted to particular data communication channel(s) and/or users. That is, the active transmitter module 105 can be configured to store feedback on prior success (e.g. based on user feedback, re-posts, re-tweets, or resending of messages) and use machine learning techniques (e.g. Monte Carlo simulations) to predict the likelihood of success of a message. The active transmitter module 105 may be provided with pre-defined thresholds or rules (e.g. stored in a memory 309) defining success of a message (e.g. amount of time in which a message is read or viewed, number of forwards of a message, etc.). In one example, the active transmitter module 105 predict the outcome of social data message by predicting whether the social data message is likely to spread to additional data communication channel(s) or to additional users or geographical regions. Accordingly, the active transmitter module 105 is configured to process the computed predictions (e.g. processor 307) and determine further amendments or modifications to the social media data (e.g. content, timing of delivery, frequency of message delivery, message destination, communication channels, languages, and/or local jargon) to improve the outcome (e.g. likelihood of successful feedback) of the social data message. The active transmitter module 105 can be configured to communicate with the other modules (e.g. 103, 104 and 106) for reconfiguring the social media data according to the parameters depicted by the prediction operation of the active transmitter module 105. As described earlier, the social data object is any one of text, a video, a picture or a photo, a graphic, audio data, or a combination thereof. As defined earlier, the active transmitter module 105 can also incorporate third party pixels, emitters, trackers etc. to provide the third party verification that a message was seen or clicked upon by a customer. The synthesizer module 106 could, alternatively incorporate the feedback from third party tracking, and use this third party feedback to bias and/or adjust the active transmitter module 105 (and corresponding transmission parameters as described herein), and ultimately adjust where, when, who, etc. see a transmitted message based using the third party transmission telemetry.

The third party data can be used singularly or in conjunction with the predictive modules described herein to help predict the user transmission targeting and/or destination.

### Social Analytic Synthesizer Module

The social analytic synthesizer module 106 is configured to perform machine learning, analytics, and to make decisions according to business driven rules. The results and recommendations determined by the social analytic synthesizer module 106 are intelligently integrated with any one or more of the active receiver module 103, the active composer module 104, and the active transmitter module 105, or any other module that can be integrated with the system 102. This module 106 may be placed or located in a number of geo locations, facilitating real time communication amongst the other modules. This arrangement or other arrangements can be used for providing low latency listening, social content creation and content transmission on a big data scale.

The social analytic synthesizer module 106 is also configured to identify unique holistic patterns, correlations, and insights. In an example embodiment, the module 106 is able to identify patterns or insights by analysing all the data from at least two other modules (e.g. any two or more of modules 103, 104 and 105), and these patterns or insights would not have otherwise been determined by individually analysing the data from each of the modules 104, 104 and 105. The feedback or an adjustment command is provided by the social analytic synthesizer module 106, in an example embodiment, in real time to the other modules. Over time and over a number of iterations, each of the modules 103, 104, 105 and 106 become more effective and efficient at continuous social communication and at their own respective operations.

Turning to FIG. 12, example components of the social analytic synthesizer module 106 are shown. Example components include a copy of data from the active receiver module 1201, a copy of data from the active composer module 1202, and a copy of data from the active transmitter module 1203. These copies of data include the inputted data obtained by each module, the intermediary data, the outputted data of each module, the algorithms and computations used by each module, the parameters used by each module, etc. Preferably, although not necessarily, these data stores 1201, 1202 and 1203 are updated frequently. In an example embodiment, the data from the other modules 103, 104, 105 are obtained by the social analytic synthesizer module 106 in real time as new data from these other modules become available.

Continuing with FIG. 12, example components also include a data store from a third party system 1204, an analytics module 1205, a machine learning module 1206 and an adjustment module 1207. The analytics module 1205 and the machine learning module 1206 process the data 1201, 1202, 1203, 1204 using currently known and future known computing algorithms to make decisions and improve processes amongst all modules (103, 104, 105, and 106).

The analytics module 1205 can communicate with the machine learning module 1206 and use a variety of approaches to analyze the social data and the associated other data as received from modules 103, 104, and 105. The analysis is performed to determine relationships, correlations, affinities, and inverse relationships within the data provided independently from each module and to cross-correlate the data from each one of the modules 103, 104 and 105 with the remaining other ones of the modules 103, 104 and 105. Non-limiting examples of algorithms that can be used to determine the relationships amongst the data include artificial neural networks, nearest neighbor, Bayesian statistics, decision trees, regression analysis, fuzzy logic, K-means algorithm, clustering, fuzzy clustering, the Monte Carlo method, learning automata, temporal difference learning, apriori algorithms, the ANOVA method, Bayesian networks, and hidden Markov models. More generally, currently known and future known analytical methods can be used to identify relationships, correlations, affinities, and inverse relationships amongst the social data obtained from the modules 103, 104 and/or 105 (as well as previous data from the synthesizer module 106). As defined earlier, the active transmitter module 105 can also incorporate third party pixels, emitters, trackers etc. to provide the third party verification that a message was seen or clicked upon by a customer. The synthesizer module 106 could, alternatively incorporate the feedback from third party tracking, and use this third party feedback to bias and/or adjust the active transmitter module 105 (and corresponding transmission parameters as described herein), and ultimately adjust where, when, who, etc. see a transmitted message based using the third party transmission telemetry.

The third party data can be used singularly or in conjunction with the predictive modules described herein to help predict the user transmission targeting and/or destination.

The adjustment module 1207 generates adjustment commands based on the results from the analytics module and the machine learning module. The adjustment commands are then sent to the respective modules (e.g. any one or more of modules 103, 104, 105, and 106).

In an example embodiment, data from a third party system 1204 can be from another social network, such as LinkedIn, Facebook, Twittter, etc.

Other example aspects of the social analytic synthesizer module 106 are below.

The social analytic synthesizer module 106 is configured to integrate data in real time from one or more sub systems and modules, included but not limited to the active receiver module 103, the active composer module 104, and the active transmitter module 105. External or third party systems can be integrated with the module 106.

The social analytic synthesizer module 106 is configured to apply machine learning and analytics to the obtained data to search for “holistic” data patterns, correlations and insights.

The social analytic synthesizer module 106 is configured to feed back, in real time, patterns, correlations and insights that were determined by the analytics and machine learning processes (e.g. analytics module 1205 and/or machine learning module 1206). The feedback is directed to the modules 103, 104, 105, and 106 and this integrated feedback loop improves the intelligence of each module and the overall system 102 over time. In yet another aspect, the synthesizer module 106 is configured to directly alter subsequent social media data generated by the system 102 prior to transmission to end users based on the criteria that the subsequent social media data is similar to prior social media data from which patterns, correlations and/or insights were determined.

The social analytic synthesizer module 106 is configured to scale the number of such modules. In other words, although the figures show one module 106, there may be multiple instances of such a module 106 to improve the effectiveness and response time of the feedback.

The social analytic synthesizer module 106 is configured to operate automatically (without any user input), and/or semi-automatically (user input for defining business rules and/or criteria for triggering retrieval of social data and/or triggering adjustment of operations of system 102).

Turning to FIG. 13, example computer or processor implemented instructions are provided for analysing data and providing adjustment commands based on the analysis, according to module 106. At block 1301, the social analytic synthesizer module obtains and stores data from the active receiver module, the active composer module and the active transmitter module. Analytics and machine learning are applied to the data (block 1302). The social analytic synthesizer determines adjustments to make in the algorithms or processes used in any of the active receiver module, active composer module, and the active transmitter module (block 1303). The adjustments, or adjustment commands, are then sent to the corresponding module or corresponding modules (block 1304).

### Determining Transmission Destination of New Messages

Although the embodiments above discuss the active transmitter module 105 changing the transmission parameters for subsequent social data. In one aspect, the feedback response 1018 and/or tracker response 1016 is forwarded to the synthesizer module 106 for defining adjustments for new social media data messages based on the feedback response 1018 and/or tracker response 1016. Additionally, the synthesizer module 106 is configured to utilize prior knowledge, prior learned patterns and pre-defined rules (e.g. as stored on memory 312 or memory 309). For example, the determined patterns may reveal one or more influencers for a particular topic. Accordingly, the synthesizer module 106 is configured to define adjustments to the operations of the source modules 103, 104 and 105 to tailor subsequent social media data of the same topic according to formatting preferences (e.g. language), content and/or destination (e.g. via the active transmitter module 105) of the revealed influencers.

General example embodiments of the systems and methods are described below.

In general, a method performed by a computing device for communicating social data, includes: obtaining social data; deriving at least two concepts from the social data; determining a relationship between the at least two concepts; composing a new social data object using the relationship; transmitting the new social data object; obtaining user feedback associated with new social data object; and computing an adjustment command using the user feedback, wherein executing the adjustment command adjusts a parameter used in the method.

In an aspect of the method, an active receiver module is configured to at least obtain the social data, derive the least two concepts from the social data, and determine the relationship between the at least two concepts; an active composer module is configured to at least compose the new social data object using the relationship; an active transmitter module is configured to at least transmit the new social data object; and wherein the active receiver module, the active composer module and the active transmitter module are in communication with each other.

In an aspect of the method, each of the active receiver module, the active composer module and the active transmitter module are in communication with a social analytic synthesizer module, and the method further includes the social analytic synthesizer module sending the adjustment command to at least one of the active receiver module, the active composer module and the active transmitter module.

In an aspect of the method, the method further includes executing the adjustment command and repeating the method.

In an aspect of the method, obtaining the social data includes the computing device communicating with multiple social data streams in real time.

In an aspect of the method, determining the relationship includes using a machine learning algorithm or a pattern recognition algorithm, or both.

In an aspect of the method, composing the new social data object includes using natural language generation.

In an aspect of the method, the method further includes determining a social communication channel over which to transmit the new social data object, and transmitting the new social data object over the social communication channel, wherein the social communication channel is determined using at least one of the at least two concepts.

In an aspect of the method, the method further includes determining a time at which to transmit the new social data object, and transmitting the new social data object at the time, wherein the time is determined using at least one of the at least two concepts.

In an aspect of the method, the method further includes adding a data tracker to the new social data object before transmitting the new social data object, wherein the data tracker facilitates collection of the user feedback.

In an aspect of the method, the new social data object is any one of text, a video, a picture, a graphic, audio data, or a combination thereof.

In general, there is provided a method performed by a computing device for communicating social data, comprising: obtaining the social data from one or more sources; composing a new social data object derived from the social data; transmitting the new social data object; obtaining at least one feedback associated with the new social data object; computing an adjustment command using said feedback, wherein executing the adjustment command adjusts at least one of steps of obtaining, composing, and transmitting for subsequent social data objects in dependence upon said feedback.

In one aspect, an active receiver module is configured to at least obtain the social data; an active composer module is configured to at least compose the new social data object; an active transmitter module is configured to at least transmit the new social data object; and wherein the active receiver module, the active composer module and the active transmitter module are in communication with a social analytic synthesizer module for computing the adjustment.

In another aspect, each feedback is weighted according to predefined rules and a higher weighting being associated with a higher degree of adjustment.

In another aspect, computing an adjustment further comprises determining patterns based on feedback associated with data from each of the active receiver module, the active composer module and the active transmitter module, the patterns for use in subsequently generating the adjustment to the respective at least one steps of obtaining, composing and transmitting subsequent social data objects.

In another aspect, computing an adjustment for the step of obtaining said at least one feedback further comprises using said patterns for deriving at least two concepts from the social data; determining a relationship between the at least two concepts; and composing the new social data object using the relationship.

In another aspect, the social data comprises a social data object and the new social data object comprises the social data object.

In another aspect, the method further comprises the social analytic synthesizer module sending the adjustment command to at least one of the active receiver module, the active composer module and the active transmitter module.

In another aspect, the method further comprises executing the adjustment command and repeating the method.

In another aspect, obtaining the social data comprises the computing device communicating with multiple social data streams in real time.

In another aspect, determining patterns comprises using at least one of: a machine learning algorithm and a pattern recognition algorithm based on prior positive feedback associated with the social data.

In another aspect, the adjustment based on said patterns further adjusts the social communication channel over which to transmit the new social data object, and the method comprises transmitting the new social data object over the social communication channel.

In another aspect, determining a time at which to transmit the new social data object, and transmitting the new social data object at the time, wherein the time is determined using detected patterns from said feedback.

In another aspect, wherein the social communication channel is determined based upon determining an inflection point of prior communication of the new social data based upon said feedback, the inflection point indicating a user that multiply broadcasts the new social data, the adjustment comprising causing subsequent transmission of social data to be transmitter to the inflection point.

In another aspect, the method further comprises transmitting the new social data object to at least one destination, wherein said at least one feedback indicates a transmission path of said new social data, the transmission path indicating re-transmission of said new social data to an alternate destination than said at least one destination and computing said adjustment comprises adjusting subsequent destination of subsequent social data objects in dependence upon said alternate destination.

In another aspect, the adjustment further comprises re-composing subsequent social data objects in dependence upon said alternate destination.

It will be appreciated that different features of the example embodiments of the system and methods, as described herein, may be combined with each other in different ways. In other words, different modules, operations and components may be used together according to other example embodiments, although not specifically stated.

The steps or operations in the flow diagrams described herein are just for example. There may be many variations to these steps or operations without departing from the spirit of the invention or inventions. For instance, the steps may be performed in a differing order, or steps may be added, deleted, or modified.

Although the above has been described with reference to certain specific embodiments, various modifications thereof will be apparent to those skilled in the art without departing from the scope of the claims appended hereto.

1. A method performed by a computing device for communicating social data, comprising:
receiving a composed social data object;
integrating at least one tracker object within the social data object;
transmitting the social data object comprising said tracker object to at least one destination target;
obtaining a response from said tracker object indicating target feedback, wherein the target feedback indicates at least one of: subsequent transmission of the social data object to additional destination targets and feedback parameters from at least one of:
said at least one destination target and said additional destination targets.

2. The method of claim 1 further comprising computing an adjustment command using the target feedback, wherein executing the adjustment command adjusts a parameter used in transmitting the social data object.

3. The method of claim 1 further comprising computing an adjustment command using the target feedback including user feedback at a target destination receiving the social data object, wherein executing the adjustment command adjusts a parameter used in composing the social data object.

4. The method of claim 1 wherein an active composer module is configured to at least compose the social data object; an active transmitter module is configured to at least transmit the social data object; and wherein the active composer module and the active transmitter module are in communication with each other.

5. The method of claim 4 wherein the active composer module and the active transmitter module are in communication with a social analytic synthesizer module, and the method further comprising the social analytic synthesizer module sending the adjustment command to at least one of the active composer module and the active transmitter module.

6. The method of claim 2 further comprising executing the adjustment command and repeating the method to monitor additional target feedback.

7. The method of claim 1 further comprising predicting target feedback based upon prior target feedback from communicating the social data object and adjusting transmission parameters associated with the social data object based upon said prediction and at least one predefined threshold defining a positive feedback.

8. The method of claim 7 wherein predicting comprises using a machine learning algorithm or a pattern recognition algorithm.

9. The method of claim 1 wherein the parameter adjusted further comprising determining a social communication channel over which to transmit the new social data object, and transmitting the social data object over the social communication channel, wherein the social communication channel is determined using said response.

10. The method of claim 1 wherein the parameter adjusted further comprises determining a time at which to transmit the social data object, and transmitting the new social data object at the time, wherein the time is determined using said response.

11. The method of claim 1 wherein the social data object is any one of text, a video, a picture, a photograph, a graphic, audio data, or a combination thereof.

12. The method of claim 1, wherein each said tracker object is configured to transmit a response from each said destination target and each said additional destination target indicating target feedback.

13. The method of claim 1, wherein the target feedback comprises at least one of: time of receipt of the social data object; read receipt for the social data object; indication of forwarding the social data object to said additional destination targets; indication of time of read of the social data object; indication of posting the social data object to additional communication channels; and indication of travel path of the social data object.

14. The method of claim 1, wherein the each said tracker object is selected from the group consisting of: emitters, cookies, pixels, and web bugs.

15. The method of claim 1, wherein the target feedback comprises at least one of: user feedback and third party feedback for subsequent use in adjusting a parameter associated with at least one of: transmission and composition of the social data object.

16. The method of claim 15, wherein the target feedback is further cross-correlated with prior target feedback to define adjustments for transmission parameters associated with the social data object.

17. A non-transitory computer readable medium comprising computer readable instructions stored on a memory, the computer readable instructions when executed on by one or more processors are configured to:
receive a composed social data object;
integrate at least one tracker object within the social data object;
transmit the social data object comprising said tracker object to at least one destination target;
track said tracker object within at least one social communication data channel;
obtain a response from said tracker object indicating target feedback, wherein the target feedback indicates at least one of: subsequent transmission of the social data object to additional destination targets and feedback parameters from at least one of: said at least one destination target and said additional destination targets;
analyze said feedback and said feedback parameters to determine positive feedback of said social data object within said social communication data channel in comparison to at least one pre-defined threshold for positive feedback;
correlate each positive feedback from each one of said destination targets to adjust subsequent transmission of said social data object.
